(19) United States
(12) Patent Application Publication
(10) Pub. No.: US 2026/0019964 A1
(43) Pub. Date: Jan. 15, 2026

(54) DYNAMIC AUTOMATIC GAIN CONTROL BASED ON TRANSMIT POWER FOR FREQUENCY BANDS WITH SMALL DUPLEX SEPARATION

(71) Applicant: QUALCOMM Incorporated, San Diego, CA (US)

(72) Inventors: Paolo MINERO, La Jolla, CA (US); Balasubramanian RAMACHANDRAN, Hyderabad (IN); Abhishek Ananthrao KULKARNI, Gulbarga (IN); Chitaranjan PELUR SUKUMAR, San Jose, CA (US); Raveesh JUNEJA, Hyderabad (IN)

(21) Appl. No.: 18/769,066

(22) Filed: Jul. 10, 2024

(51) Int. Cl. H04W 52/52; H04L 5/14

(52) U.S. Cl. CPC H04W 52/52; H04L 5/14

(57) ABSTRACT

Aspects relate to mechanisms for dynamically modifying the gain applied to a received signal based on the transmit power of a transmit signal. The transmit signal may be transmitted in a first frequency band and the received signal may be received in a second frequency band, where the frequency separation between the first frequency band and the second frequency band is less than a threshold.

### TECHNICAL FIELD

The technology discussed below relates generally to wireless communication systems, and more particularly, to automatic gain control (AGC) in user equipment (UE) operating in frequency bands with a small duplex separation.

### INTRODUCTION

Wireless communication systems, such as those specified under fifth generation (5G) systems, referred to as New Radio (NR) systems, sixth generation (6G) systems, and other future generation systems, may be widely deployed to provide various types of communication content such as voice, video, packet data, messaging, broadcast, and so on. These systems may be accessed by various types of wireless devices adapted to facilitate wireless communications, where multiple devices share the available system resources (e.g., time, frequency, and power).

Wireless devices, such as user equipment (UE), may implement automatic gain control (AGC) of amplifiers in the transmitter and the receiver to maintain acceptable levels of signals in the transmit and receive chains. For example, an AGC module in the receiver may be utilized to control the gain of a low noise amplifier (LNA) to prevent saturation/clipping of downstream active radio frequency (RF) components.

### BRIEF SUMMARY OF SOME EXAMPLES

The following presents a summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a form as a prelude to the more detailed description that is presented later.

In one example, an apparatus configured for wireless communication at a user equipment (UE) includes one or more memories and one or more processors coupled to the one or more memories. The one or more processors can be configured to transmit a transmit signal at a transmit power in a first frequency band of frequency division duplex (FDD) pair and receive a received signal in a second frequency band of the FDD pair, where a frequency separation between the first frequency band and the second frequency band is less than a first threshold. The one or more processors can further be configured to modify an analog gain applied to the received signal based on the transmit power.

Another example provides a method operable at a user equipment (UE). The method includes transmitting a transmit signal at a transmit power in a first frequency band and receiving a received signal in a second frequency band, where a frequency separation between the first frequency band and the second frequency band is less than a first threshold. The method further includes modifying an analog gain applied to the received signal based on the transmit power.

Another example provides an apparatus configured for wireless communication at a user equipment (UE) including means for transmitting a transmit signal at a transmit power in a first frequency band and means for receiving a received signal in a second frequency band, where a frequency separation between the first frequency band and the second frequency band is less than a first threshold. The apparatus further includes means for modifying an analog gain applied to the received signal based on the transmit power.

These and other aspects will become more fully understood upon a review of the detailed description, which follows. Other aspects, features, and examples will become apparent to those of ordinary skill in the art upon reviewing the following description of specific exemplary aspects in conjunction with the accompanying figures. While features may be discussed relative to certain examples and figures below, all examples can include one or more of the features discussed herein. In other words, while one or more examples may be discussed as having certain features, one or more of such features may also be used in accordance with the various examples discussed herein. Similarly, while examples may be discussed below as device, system, or method examples, it should be understood that such examples can be implemented in various devices, systems, and methods.

### BRIEF DESCRIPTION OF THE DRAWINGS

FIG. 1 is a diagram illustrating an example of a wireless communication system and an access network according to some aspects.

FIG. 2 is a diagram illustrating an example of leakage of a transmit signal onto a receive chain of a user equipment (UE) according to some aspects.

FIG. 3 is a diagram illustrating an example of frequency bands with small duplex separations therebetween according to some aspects.

FIG. 4 is a diagram illustrating an example of gain states based on receive power levels according to some aspects.

FIG. 5 is a diagram illustrating an example of dynamic automatic gain control (AGC) of received signals based on transmit power according to some aspects.

FIG. 6 is a diagram illustrating dynamic AGC modes based on transmit power according to some aspects.

FIG. 7 is a flow chart illustrating an exemplary process for dynamic AGC based on transmit power according to some aspects.

FIG. 8 is a flow chart illustrating another exemplary process for dynamic AGC based on transmit power according to some aspects.

FIG. 9 is a diagram illustrating separation of receive power and transmit leakage power for AGC according to some aspects.

FIG. 10 is a flow chart illustrating an exemplary process for dynamic AGC based on both the receive power and the transmit power leakage according to some aspects.

FIG. 11 is a diagram illustrating an example of energy estimation of the receive power and the transmit power leakage according to some aspects.

FIGS. 12A and 12B are diagrams illustrating an example of energy estimation of the transmit power leakage according to some aspects.

FIG. 13 is a flow chart illustrating an exemplary process for energy estimation of the transmit power leakage according to some aspects.

FIGS. 14A-14C are diagrams illustrating another example of energy estimation of the transmit power leakage according to some aspects.

FIG. 15 is a flow chart illustrating another exemplary process for energy estimation of the transmit power leakage according to some aspects.

FIG. 16 is a block diagram illustrating an example of a hardware implementation for a user equipment (UE) employing a processing system according to some aspects.

FIG. 17 is a flow chart illustrating an exemplary process for dynamic AGC based on transmit power according to some aspects.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

While aspects and examples are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, aspects and/or uses may come about via integrated chip examples and other non-module-component-based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for the implementation and practice of claimed and described examples. For example, transmission and reception of wireless signals necessarily includes a number of components for analog and digital purposes (e.g., hardware components including antenna, radio frequency (RF) chains (RF-chains), power amplifiers, modulators, buffer, processor(s), interleaver, adders/summers, etc.). It is intended that innovations described herein may be practiced in a wide variety of devices, chip-level components, systems, distributed arrangements, disaggregated arrangements (e.g., network entity and/or UE), end-user devices, etc., of varying sizes, shapes, and constitution.

In orthogonal frequency division modulation (OFDM) systems, the peak-to-average power ratio (PAPR) of time-varying waveforms is non-zero, thus resulting in fluctuations in the signal itself. Variations in the signal strength of received signals may also occur due to changes in the wireless environment (e.g., path loss, fading, etc.). Therefore, many wireless devices, such as user equipment (UE), include automatic gain control (AGC) modules to control the level or gain of the received signal to prevent clipping or saturation of active RF components in the receive chain. AGC modules continuously monitor the power of the received signal (e.g., by monitoring the received signal strength indicator (RSSI)) and modify the analog gain to be applied to the received signal based on the RSSI. For example, AGC may be utilized to apply a particular gain state to a low noise amplifier (LNA) in the receiver.

However, in frequency division duplex (FDD) bands with small duplex separation (e.g., 25 MHz separation) between the uplink and downlink frequency bands, out-of-band leakage of the transmit signal may cause desensitization of the receiver and therefore impact the receiver functionality and performance. To prevent saturation/clipping of active RF components due to the additional signal power caused by the transmit signal interference, the AGC module may be configured to statically lower the analog gain applied to the received signal in the LNA in frequency bands that may experience transmit power leakage, as compared to what would normally be applied in a frequency band without transmit power leakage. However, providing such a static power back-off in frequency bands that may experience transmit power leakage may come at the cost of reduced downlink performance. For example, a reduction in the power back-off to prevent the active RF components from saturating may cause a degradation of the achievable signal-to-noise ratio (SNR), which in turn may reduce the downlink performance.

Various aspects are related to mechanisms for a UE to dynamically modify the gain applied to a received signal based on the transmit power of a transmit signal sent by the UE. The transmit signal may be transmitted in a first frequency band and the received signal may be received in a second frequency band, where the frequency separation between the first frequency band and the second frequency band is less than a threshold. In some examples, the UE may reduce the analog gain applied to a low noise amplifier (LNA) of a receiver of the UE. For example, the UE may increase a gain state of the LNA to reduce the analog gain.

In some examples, the UE may modify the analog gain in response to the transmit power being greater than a second threshold. For example, the UE may determine an expected transmit power in a next time element (e.g., a slot or a symbol) and modify the analog gain in that next time element in response to the expected transmit power being greater than a threshold. In some examples, an AGC module in the receiver may query a AGC module of a transmitter of the UE for the expected transmit power. In some examples, the UE may modify an estimated RSSI of the received signal (e.g., by adding a static bias to the estimated RSSI) in response to the transmit power being greater than the second threshold. An additional hysteresis amount may further be added to the static bias to prevent toggling between gain states over time.

In some examples, the UE may modify the analog gain by selecting a maximum gain state between respective gain states ascertained for both the received signal (e.g., without a transmit leakage component) and the transmit leakage component. For example, the UE may estimate a first RSSI of the received signal without the transmit leakage component and identify a first gain state based on the first RSSI. The UE may further estimate a second RSSI of the transmit leakage component and identify a second gain state based on the second RSSI. The UE may then select the maximum gain state between the first and second gain states to be applied to the LNA. In some examples, the first RSSI is reduced by a first setpoint amount of an analog-to-digital converter (ADC) in the receiver and the second RSSI is reduced by a second setpoint amount of the ADC. The first and second setpoint amounts may be configured to provide an adequate headroom to accommodate variations in the time domain waveform of the received signal (e.g., due to the variations in the PAPR and as a result of the wireless environment due to path loss, fading, etc.). The second setpoint amount may be less than the first setpoint amount since less headroom may be needed for the transmit signal due to the fact that the leakage power from the transmit signal does not experience variations caused by the wireless environment.

In some examples, the transmit leakage RSSI may be determined by capturing a wideband signal (e.g., by increasing the sampling rate of the ADC and tuning the filter poles such that the transmit leaked signal falls in-band) and rotating the wideband signal to re-center the wideband signal around a transmit enter frequency to measure the RSSI of the transmit power leakage. In other examples, the transmit leakage RSSI may be determined by capturing the received signal (e.g., without increasing the sampling rate of the ADC or tuning the filter poles), rotating the received signal to re-center the received signal around the transmit center frequency, measuring an attenuated RSSI of the transmit power leakage, and scaling the attenuated RSSI by a scaling factor to produce the transmit leakage RSSI. For example, the UE may access a look-up table (LUT) mapping the scaling factor to the attenuated RSSI to determine the scaling factor to apply to the attenuated RSSI.

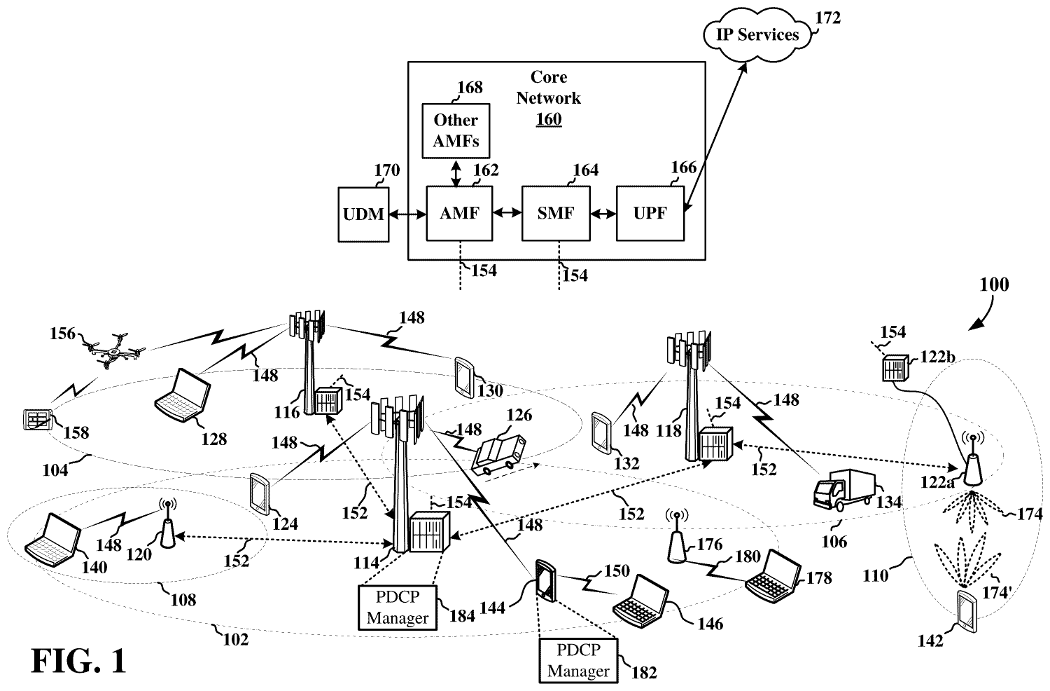

The various concepts presented throughout this disclosure may be implemented across a broad variety of telecommunication systems, network architectures, and communication standards. Referring now to FIG. 1, as an illustrative example without limitation, a schematic illustration of a wireless communication network including a radio access network (RAN) 100 and a core network 160 is provided. The RAN 100 may implement any suitable wireless communication technology or technologies to provide radio access. As one example, the RAN 100 may operate according to 3^{rd} Generation Partnership Project (3GPP) New Radio (NR) specifications, often referred to as 5G. As another example, the RAN 100 may operate under a hybrid of 5G NR and Evolved Universal Terrestrial Radio Access Network (eUTRAN) standards, often referred to as LTE. The 3GPP refers to this hybrid RAN as a next-generation RAN, or NG-RAN. In other examples, the RAN 100 may operate according to a hybrid of 5G NR and 6G, may operate according to 6G, or may operate according to other future radio access technology (RAT). Of course, many other examples may be utilized within the scope of the present disclosure.

The geographic region covered by the RAN 100 may be divided into a number of cellular regions (cells) that can be uniquely identified by a user equipment (UE) based on an identification broadcasted over a geographical area from one access point or network entity. FIG. 1 illustrates cells 102, 104, 106, 108, and 110 each of which may include one or more sectors (not shown). A sector is a sub-area of a cell. All sectors within one cell are served by the same network entity. A radio link within a sector can be identified by a single logical identification belonging to that sector. In a cell that is divided into sectors, the multiple sectors within a cell can be formed by groups of antennas with each antenna responsible for communication with UEs in a portion of the cell.

In general, a respective network entity serves each cell. Broadly, a network entity is responsible for radio transmission and reception in one or more cells to or from a UE. A network entity may also be referred to by those skilled in the art as a base station (e.g., an aggregated base station or disaggregated base station), base transceiver station (BTS), a radio base station, a radio transceiver, a transceiver function, a basic service set (BSS), an extended service set (ESS), an access point (AP), a Node B (NB), an evolved NB (eNB), a 5G NB (gNB), a transmission receive point (TRP), or some other suitable terminology. In some examples, a network entity may include two or more TRPs that may be collocated or non-collocated. Each TRP may communicate on the same or different carrier frequency within the same or different frequency band. In examples where the RAN 100 operates according to both the LTE and 5G NR standards, one of the network entities may be an LTE network entity, while another network entity may be a 5G NR network entity.

In some examples, the RAN 100 may employ an open RAN (O-RAN) to provide a standardization of radio interfaces to procure interoperability between component radio equipment. For example, in an O-RAN, the RAN may be disaggregated into a centralized unit (CU), a distributed unit (DU), and a radio unit (RU). The RU is configured to transmit and/or receive (RF) signals to and/or from one or more UEs. The RU may be located at, near, or integrated with, an antenna. The DU and the CU provide computational functions and may facilitate the transmission of digitized radio signals within the RAN 100. In some examples, the DU may be physically located at or near the RU. In some examples, the CU may be located near the core network 160.

The DU provides downlink and uplink baseband processing, a supply system synchronization clock, signal processing, and an interface with the CU. The RU provides downlink baseband signal conversion to an RF signal, and uplink RF signal conversion to a baseband signal. The O-RAN may include an open fronthaul (FH) interface between the DU and the RU. Aspects of the disclosure may be applicable to an aggregated RAN and/or to a disaggregated RAN (e.g., an O-RAN).

Various network entity arrangements can be utilized. For example, in FIG. 1, network entities 114, 116, and 118 are shown in cells 102, 104, and 106; and another network entity 122 is shown controlling a remote radio head (RRH) 122 in cell 110. That is, a network entity can have an integrated antenna or can be connected to an antenna or RRH by feeder cables. In the illustrated example, the cells 102, 104, 106, and 110 may be referred to as macrocells, as the network entities 114, 116, 118, and 122 support cells having a large size. Further, a network entity 120 is shown in the cell 108 which may overlap with one or more macrocells. In this example, the cell 108 may be referred to as a small cell (e.g., a microcell, picocell, femtocell, home base station, home Node B, home eNode B, etc.), as the network entity 120 supports a cell having a relatively small size. Cell sizing can be done according to system design as well as component constraints.

It is to be understood that the RAN 100 may include any number of network entities and cells. Further, a relay node may be deployed to extend the size or coverage area of a given cell. In some examples, a cell may not necessarily be stationary, and the geographic area of the cell may move according to the location of a mobile network entity.

FIG. 1 further includes an unmanned aerial vehicle (UAV) 156, which may be a drone or quadcopter. The UAV 156 may be configured to function as a network entity, or more specifically as a mobile network entity. That is, in some examples, a cell may not necessarily be stationary, and the geographic area of the cell may move according to the location of a mobile network entity such as the UAV 156.

In addition to other functions, the network entities 114, 116, 118, 120, and 122a/122b may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The network entities 114, 116, 118, 120, and 122a/122b may communicate directly or indirectly (e.g., through the core network 170) with each other over backhaul links 152 (e.g., X2 interface). The backhaul links 152 may be wired or wireless.

The RAN 100 is illustrated supporting wireless communication for multiple mobile apparatuses. A mobile apparatus is commonly referred to as user equipment (UE) in standards and specifications promulgated by the 3^{rd} Generation Partnership Project (3GPP), but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. A UE may be an apparatus that provides a user with access to network services.

Within the present document, a “mobile” apparatus need not necessarily have a capability to move, and may be stationary. The term mobile apparatus or mobile device broadly refers to a diverse array of devices and technologies. For example, some non-limiting examples of a mobile apparatus include a mobile, a cellular (cell) phone, a smart phone, a session initiation protocol (SIP) phone, a laptop, a personal computer (PC), a notebook, a netbook, a smartbook, a tablet, a personal digital assistant (PDA), and a broad array of embedded systems, e.g., corresponding to an “Internet of things” (IoT). A mobile apparatus may additionally be an automotive or other transportation vehicle, a remote sensor or actuator, a robot or robotics device, a satellite radio, a global positioning system (GPS) device, an object tracking device, a drone, a multi-copter, a quad-copter, a remote control device, a consumer and/or wearable device, such as eyewear, a wearable camera, a virtual reality device, a smart watch, a health or fitness tracker, a digital audio player (e.g., MP3 player), a camera, a game console, etc. A mobile apparatus may additionally be a digital home or smart home device such as a home audio, video, and/or multimedia device, an appliance, a vending machine, intelligent lighting, a home security system, a smart meter, etc. A mobile apparatus may additionally be a smart energy device, a security device, a solar panel or solar array, a municipal infrastructure device controlling electric power (e.g., a smart grid), lighting, water, etc., an industrial automation and enterprise device, a logistics controller, agricultural equipment, etc. Still further, a mobile apparatus may provide for connected medicine or telemedicine support, i.e., health care at a distance. Telehealth devices may include telehealth monitoring devices and telehealth administration devices, whose communication may be prioritized access over other types of information, e.g., in terms of prioritized access for transport of critical service data, and/or relevant QoS for transport of critical service data.

Within the RAN 100, the cells may include UEs that may be in communication with one or more sectors of each cell. For example, UEs 124, 126, and 144 may be in communication with network entity 114; UEs 128 and 130 may be in communication with network entity 116; UEs 132 and 138 may be in communication with network entity 118; UE 140 may be in communication with network entity 120; UE 142 may be in communication with network entity 122a via RRH 122b; and UE 158 may be in communication with mobile network entity 156. Here, each network entity 114, 116, 118, 120, 122a/122b, and 156 may be configured to provide an access point to the core network 170 (not shown) for all the UEs in the respective cells. In another example, a mobile network node (e.g., UAV 156) may be configured to function as a UE. For example, the UAV 156 may operate within cell 104 by communicating with network entity 116. UEs may be located anywhere within a serving cell. UEs that are located closer to a center of a cell (e.g., UE 132) may be referred to as cell center UEs, whereas UEs that are located closer to an edge of a cell (e.g., UE 134) may be referred to as cell edge UEs. Cell center UEs may have a higher signal quality (e.g., a higher reference signal received power (RSRP) or signal-to interference-plus-noise ratio (SINR)) than cell edge UEs.

In the RAN 100, the ability for a UE to communicate while moving, independent of their location, is referred to as mobility. The various physical channels between the UE and the RAN are generally set up, maintained, and released under the control of an access and mobility management function (AMF), which may include a security context management function (SCMF) that manages the security context for both the control plane and the user plane functionality and a security anchor function (SEAF) that performs authentication. In some examples, during a call facilitated by a network entity, or at any other time, a UE may monitor various parameters of the signal from its serving cell as well as various parameters of neighboring cells. Depending on the quality of these parameters, the UE may maintain communication with one or more of the neighboring cells. During this time, if the UE moves from one cell to another, or if signal quality from a neighboring cell exceeds that from the serving cell for a given amount of time, the UE May undertake a handoff or handover from the serving cell to the neighboring (target) cell. For example, UE 126 may move from the geographic area corresponding to its serving cell 102 to the geographic area corresponding to a neighbor cell 106. When the signal strength or quality from the neighbor cell 106 exceeds that of its serving cell 102 for a given amount of time, the UE 126 may transmit a reporting message to its serving network entity 114 indicating this condition. In response, the UE 126 may receive a handover command, and the UE may undergo a handover to the cell 106.

Wireless communication between a RAN 100 and a UE (e.g., UE 124, 126, or 144) may be described as utilizing communication links 148 over an air interface. Transmissions over the communication links 148 between the network entities and the UEs may include uplink (UL) (also referred to as reverse link) transmissions from a UE to a network entity and/or downlink (DL) (also referred to as forward link) transmissions from a network entity to a UE. For example, DL transmissions may include unicast or broadcast transmissions of control information and/or data (e.g., user data traffic or other type of traffic) from a network entity (e.g., network entity 114) to one or more UEs (e.g., UEs 124, 126, and 144), while UL transmissions may include transmissions of control information and/or traffic information originating at a UE (e.g., UE 124). In addition, the uplink and/or downlink control information and/or traffic information may be time-divided into frames, subframes, slots, and/or symbols. As used herein, a symbol may refer to a unit of time that, in an orthogonal frequency division multiplexed (OFDM) waveform, carries one resource element (RE) per sub-carrier. A slot may carry 7 or 14 OFDM symbols. A subframe may refer to a duration of Ims. Multiple subframes or slots may be grouped together to form a single frame or radio frame. Within the present disclosure, a frame may refer to a predetermined duration (e.g., 10 ms) for wireless transmissions, with each frame consisting of, for example, 10 subframes of 1 ms each. Of course, these definitions are not required, and any suitable scheme for organizing waveforms may be utilized, and various time divisions of the waveform may have any suitable duration.

The communication links 148 may use multiple-input and multiple-output (MIMO) antenna technology, including spatial multiplexing, beamforming, and/or transmit diversity. For example, as shown in FIG. 1, network entity 122a/122b may transmit a beamformed signal to the UE 142 via one or more beams 174 in one or more transmit directions. The UE 142 may further receive the beamformed signal from the network entity 122a/122b via one or more beams 174′ in one or more receive directions. The UE 142 may also transmit a beamformed signal to the network entity 122a/122b via the one or more beams 174′ in one or more transmit directions. The network entity 122a/122b may further receive the beamformed signal from the UE 142 via the one or more beams 174 in one or more receive directions. The network entity 122a/122b and the UE 142 may perform beam training to determine the best transmit and receive beams 174/174′ for communication between the network entity 122a/122b and the UE 142. The transmit and receive beams for the network entity 122a/122b may or may not be the same. The transmit and receive directions for the UE 142 may or may not be the same.

The communication links 148 may utilize one or more carriers. The network entities and UEs may use spectrum up to Y MHz (e.g., 5, 10, 15, 20, 100, 400, etc. MHZ) bandwidth per carrier allocated in a carrier aggregation of up to a total of Yx MHZ (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

The communication links 148 in the RAN 100 may further utilize one or more multiplexing and multiple access algorithms to enable simultaneous communication of the various devices. For example, 5G NR specifications provide multiple access for UL or reverse link transmissions from UEs 124, 126, and 144 to network entity 114, and for multiplexing DL or forward link transmissions from the network entity 114 to UEs 124, 126, and 144 utilizing orthogonal frequency division multiplexing (OFDM) with a cyclic prefix (CP). In addition, for UL transmissions, 5G NR specifications provide support for discrete Fourier transform-spread-OFDM (DFT-s-OFDM) with a CP (also referred to as single-carrier FDMA (SC-FDMA)). However, within the scope of the present disclosure, multiplexing and multiple access are not limited to the above schemes, and may be provided utilizing time division multiple access (TDMA), code division multiple access (CDMA), frequency division multiple access (FDMA), sparse code multiple access (SCMA), resource spread multiple access (RSMA), or other suitable multiple access schemes. Further, multiplexing DL transmissions from the network entity 114 to UEs 124, 126, and 144 may be provided utilizing time division multiplexing (TDM), code division multiplexing (CDM), frequency division multiplexing (FDM), orthogonal frequency division multiplexing (OFDM), sparse code multiplexing (SCM), or other suitable multiplexing schemes.

Further, the communication links 148 in the RAN 100 may utilize one or more duplexing algorithms. Duplex refers to a point-to-point communication link where both endpoints can communicate with one another in both directions. Full-duplex means both endpoints can simultaneously communicate with one another. Half-duplex means only one endpoint can send information to the other at a time. Half-duplex emulation is frequently implemented for wireless links utilizing time division duplex (TDD). In TDD, transmissions in different directions on a given channel are separated from one another using time division multiplexing. That is, at some times the channel is dedicated for transmissions in one direction, while at other times the channel is dedicated for transmissions in the other direction, where the direction may change very rapidly, e.g., several times per slot. In a wireless link, a full-duplex channel generally relies on physical isolation of a transmitter and receiver, and suitable interference cancellation technologies. Full-duplex emulation is frequently implemented for wireless links by utilizing frequency division duplex (FDD) or spatial division duplex (SDD). In FDD, transmissions in different directions may operate at different carrier frequencies (e.g., within paired spectrum). In SDD, transmissions in different directions on a given channel are separated from one another using spatial division multiplexing (SDM). In other examples, full-duplex communication may be implemented within unpaired spectrum (e.g., within a single carrier bandwidth), where transmissions in different directions occur within different sub-bands of the carrier bandwidth. This type of full-duplex communication may be referred to herein as sub-band full duplex (SBFD), also known as flexible duplex (FD).

In various implementations, the communication links 148 in the RAN 100 may utilize licensed spectrum, unlicensed spectrum, or shared spectrum. Licensed spectrum provides for exclusive use of a portion of the spectrum, generally by virtue of a mobile network operator purchasing a license from a government regulatory body. Unlicensed spectrum provides for shared use of a portion of the spectrum without need for a government-granted license. While compliance with some technical rules is generally still required to access unlicensed spectrum, generally, any operator or device may gain access. Shared spectrum may fall between licensed and unlicensed spectrum, wherein technical rules or limitations may be required to access the spectrum, but the spectrum may still be shared by multiple operators and/or multiple RATs. For example, the holder of a license for a portion of licensed spectrum may provide licensed shared access (LSA) to share that spectrum with other parties, e.g., with suitable licensee-determined conditions to gain access.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR2-2, and/or FR5, or may be within the EHF band.

In some examples, access to the air interface may be scheduled, wherein a scheduling entity (e.g., a network entity 114) allocates resources for communication among some or all devices and equipment within its service area or cell. Within the present disclosure, as discussed further below, the scheduling entity may be responsible for scheduling, assigning, reconfiguring, and releasing resources for one or more scheduled entities. That is, for scheduled communication, UEs (e.g., UE 124), which may be scheduled entities, may utilize resources allocated by the scheduling entity 114.

Network entities are not the only entities that may function as scheduling entities. That is, in some examples, a UE may function as a scheduling entity, scheduling resources for one or more scheduled entities (e.g., one or more other UEs). For example, two or more UEs (e.g., UEs 144 and 146) may communicate with each other using peer to peer (P2P) or sidelink signals via a sidelink 150 therebetween without relaying that communication through a network entity (e.g., network entity 114). In some examples, the UEs 144 and 146 may each function as a scheduling entity or transmitting sidelink device and/or a scheduled entity or a receiving sidelink device to communicate sidelink signals therebetween without relying on scheduling or control information from a network entity (e.g., network entity 114). In other examples, the network entity 114 may allocate resources to the UEs 144 and 146 for sidelink communication. For example, the UEs 144 and 146 may communicate using sidelink signaling in a P2P network, a device-to-device (D2D) network, vehicle-to-vehicle (V2V) network, a vehicle-to-everything (V2X), a mesh network, or other suitable network.

In some examples, a D2D relay framework may be included within a cellular network to facilitate relaying of communication to/from the network entity 114 via D2D links (e.g., sidelink 150). For example, one or more UEs (e.g., UE 144) within the coverage area of the network entity 114 may operate as a relaying UE to extend the coverage of the network entity 114, improve the transmission reliability to one or more UEs (e.g., UE 146), and/or to allow the network entity to recover from a failed UE link due to, for example, blockage or fading.

The wireless communications system may further include a Wi-Fi access point (AP) 176 in communication with Wi-Fi stations (STAs) 178 via communication links 180 in a 5 GHz unlicensed frequency spectrum. When communicating in an unlicensed frequency spectrum, the STAs 170/AP 176 may perform a clear channel assessment (CCA) prior to communicating in order to determine whether the channel is available.

The network entities 114, 116, 118, 120, and 122a/122b provide wireless access points to the core network 160 for any number of UEs or other mobile apparatuses via core network backhaul links 154. The core network backhaul links 154 may provide a connection between the network entities 114, 116, 118, 120, and 122a/122b and the core network 170. In some examples, the core network backhaul links 154 may include backhaul links 152 that provide interconnection between the respective network entities. The core network may be part of the wireless communication system and may be independent of the radio access technology used in the RAN 100. Various types of backhaul interfaces may be employed, such as a direct physical connection (wired or wireless), a virtual network, or the like using any suitable transport network.

The core network 160 may include an Access and Mobility Management Function (AMF) 162, other AMFs 168, a Session Management Function (SMF) 164, and a User Plane Function (UPF) 166. The AMF 162 may be in communication with a Unified Data Management (UDM) 170. The AMF 162 is the control node that processes the signaling between the UEs and the core network 160. Generally, the AMF 162 provides QoS flow and session management. All user Internet protocol (IP) packets are transferred through the UPF 166. The UPF 166 provides UE IP address allocation as well as other functions. The UPF 166 is configured to couple to IP Services 172. The IP Services 172 may include the Internet, an intranet, an IP Multimedia Subsystem (IMS), a PS Streaming Service, and/or other IP services.

In frequency division duplex (FDD) bands with small duplex separation between the uplink and downlink frequency bands or other NR carrier aggregation (CA) or E-UTRAN NR-Dual Connectivity (ENDC) scenarios, out-of-band leakage of the transmit signal into the received signal may occur, resulting in possible clipping or saturation of active RF components in the receive chain.

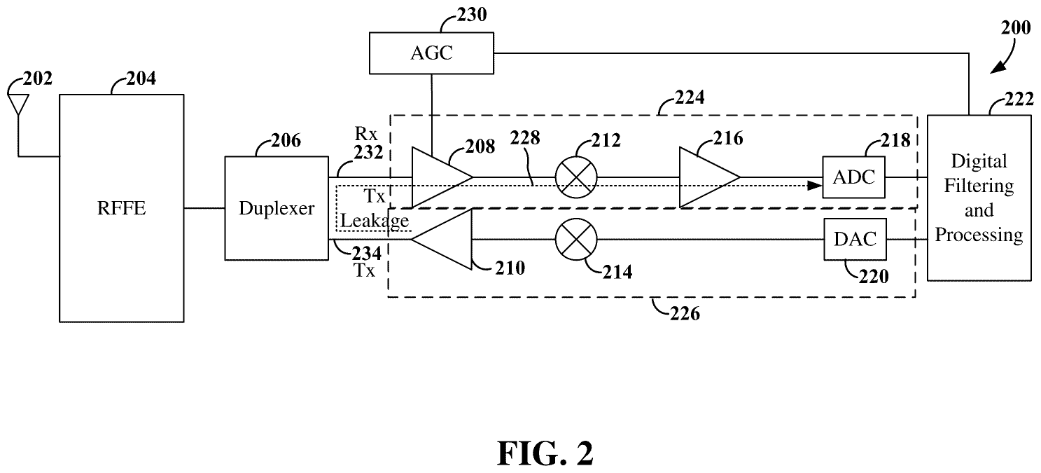

FIG. 2 is a diagram illustrating an example of leakage of a transmit signal onto a receiver of a user equipment (UE) according to some aspects. In the example shown in FIG. 2, a UE 200 includes a radio frequency front end (RFFE) 204 coupled to an antenna module 202 (e.g., one or more antenna modules, each corresponding to an antenna panel or antenna array). The RFFE 204 includes various front-end components, such as an antenna switch module (ASM), diplexers, analog filters, etc. The RFFE 204 is coupled to a duplexer 206 configured to enable bi-directional communication over a wireless channel by isolating a receiver 224 of the UE from a transmitter 226 of the UE 200, while coupling both the receiver 224 and the transmitter 226 to the antenna module 202.

The receiver 224 includes a low noise amplifier 208, an RF mixer 212 (e.g., down-conversion module configured to convert a received analog RF signal (Rx 232) to an intermediate or baseband frequency), one or more additional amplifiers 216 and filters (not shown), and an analog-to-digital converter (ADC) 218. For example, the additional amplifiers 216 may include a transimpedance amplifier (TIA) and/or a programmable gain amplifier (PGA). The transmitter 226 includes a power amplifier 210, RF mixer 214 (e.g., up-conversion module configured to convert the received analog intermediate or baseband signal to an analog RF signal (Tx 234)), one or more filters and/or additional amplifiers (not shown), and a digital-to-analog converter (DAC) 220. The ADC 218 and DAC 220 are each coupled to a digital filtering and processing module 222 configured to filter and process digital downlink and/or uplink signals from and/or to the receiver 224 and the transmitter 226. In some examples, the ADC 218 and DAC 220 may each be incorporated into a modem of the UE. In other examples, the ADC 218 and DAC 220 may be incorporated into an RF system of the UE that includes the RFFE 204 and other analog wireless transceiver circuitry.

Each of the receiver 224 and the transmitter 226 may include an automatic gain control (AGC) module 230 (the former being illustrated) configured to maintain a suitable signal amplitude at the output of the LNA 208 or the PA 210, respectively. For example, in the receiver 224, the AGC 230 may be configured to dynamically adjust the gain of the LNA 208 due to variations in the received signal strength. To adjust the gain, the AGC module 230 may adjust a gain state of the LNA 208. Gain states may include, for example, gain states G0, G1, and G2, with G0 providing the highest gain and G2 providing the lowest gain. For example, the gain may decrease with G0>G1>G2.

However, as illustrated in FIG. 2, in FDD bands with small separation between the downlink and uplink frequency bands, a portion of the Tx signal 234 may leak into the Rx signal 232, and the resulting Tx leakage 228 may impact the performance of various components in the receiver 224. For example, the additional signal power caused by the Tx leakage 228 (Tx interference) may cause saturation/clipping of various active RF components, such as the TIA 216, in the receiver 224.

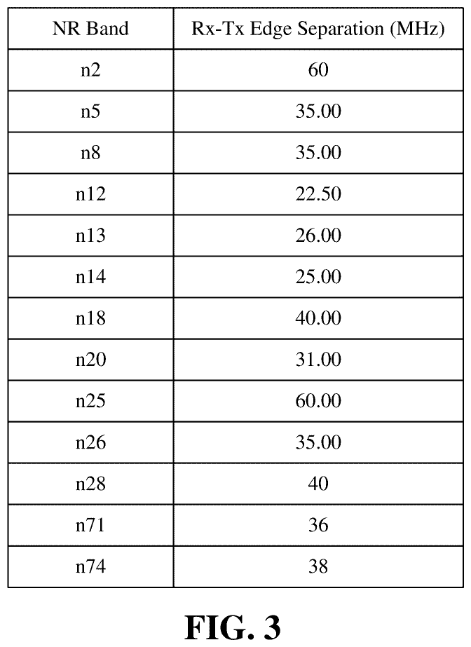

FIG. 3 is a diagram illustrating an example of frequency bands with small duplex separations therebetween according to some aspects. In the example shown in FIG. 3, NR FDD bands n12, n13, and n14 each have an Rx-Tx edge band separation less than 30 MHz. With such limited isolation, out-of-band leakage of the Tx signal (e.g., as shown in FIG. 2) can cause desensitization of the receiver, and therefore, impact the receiver functionality and performance. To prevent saturation/clipping of various RF components, such as the TIA shown in FIG. 2, the UE may lower the analog gain applied to the Rx signal in the LNA in such problematic FDD bands, as compared to what would be applied in a band where there is no Tx leakage.

In an example, to prevent saturation/clipping, the TIA maximum swing may need to be less than 900 mV. To achieve this target, the LNA gain state of G0 or both G0 and G1 may need to be avoided in certain FDD bands. In this example, the receiver AGC may be forced to operate in a gain state that provides a lower gain for the LNA (e.g., G1 or G2) in order to protect the RF components. For example, the receiver AGC may statically switch to G1 or G2 at lower receive power levels than the AGC may otherwise switch in such problematic frequency bands.

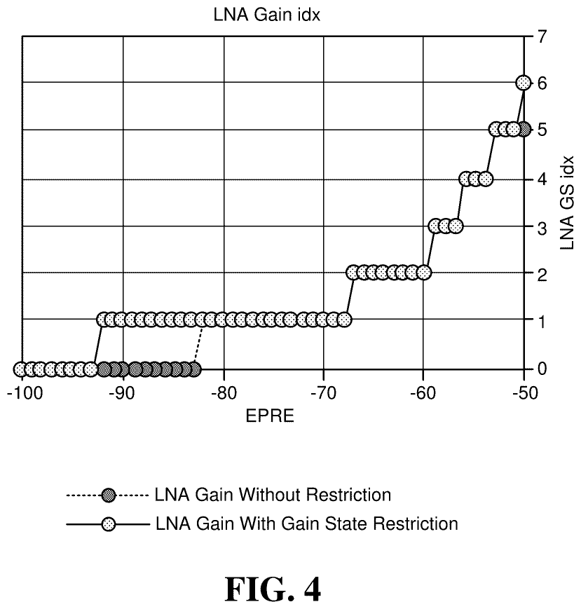

FIG. 4 is a diagram illustrating an example of gain states based on receive power levels according to some aspects. In the example shown in FIG. 4, the receive power level (e.g., EPRE) is plotted against the LNA gain state (GS) index (e.g., G0, G1, G2) for both a normal LNA gain without restriction for problematic FDD bands and a modified LNA gain with restriction for problematic FDD bands. As can be seen in FIG. 4, with the LNA gain restriction for problematic FDD bands, the LNA GS Index switches to G1 at a lower EPRE point (e.g., receive power level) as compared to the normal LNA gain without restriction. This difference in LNA gain state may result in SNR loss in throughput of the receiver if the receiver AGC is not operating at the correct GS based on the actual/current transmit leakage power.

Various aspects are directed to recovering part of the performance loss resulting from switching gain states to lower the LNA gain in FDD bands with small duplex separation. Since the transmit power is not always at the maximum value (e.g., depending on the presence of an uplink grant, the path loss between the UE and the network entity, and other factors), the UE may dynamically determine the LNA gain to be applied based on the transmit power in such problematic frequency bands (e.g., FDD bands with small duplex separation or other ENDC or NR CA problematic frequency bands). For example, if there is no transmit activity (e.g., no transmit signal currently being transmitted by the UE) or if the transmit power of the transmit signal is low (e.g., less than a threshold), then the LNA gain may be set as normal (e.g., the same as for any other frequency band), and as such, there is no performance impact to the downlink performance (e.g., received signal). However, if the transmit power is high (e.g., above a threshold) and as a result, the transmit leakage power is high due to transmission/reception on closely related FDD bands, the LNA gain may be set to a lower level (e.g., G1 or G2) in order protect the RF receiver components.

In some examples, the transmit power may be estimated based on the expected transmit power in a next slot or symbol. The estimated transmit power may then be used to set the LNA gain. In other examples, the transmit leakage power observed in the received signal may be used to determine the LNA gain. For example, the receive power and transmit leakage power may be separately estimated and the respective gain states for each power may be ascertained. The maximum gain state between the receive power and transmit leakage power can then be selected.

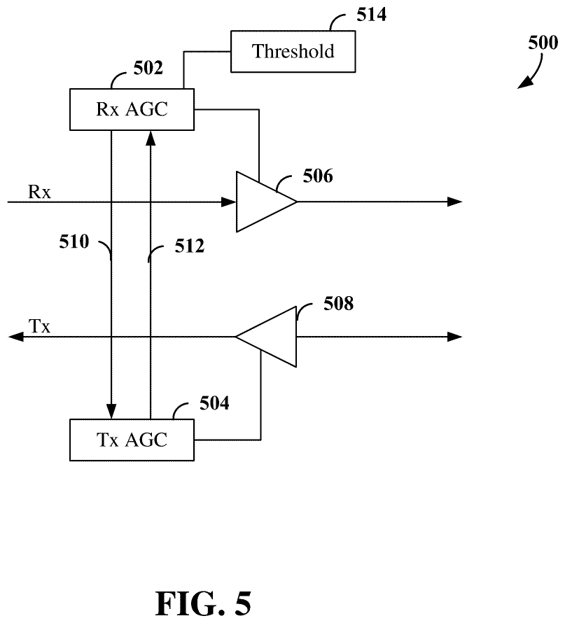

FIG. 5 is a diagram illustrating an example of dynamic automatic gain control (AGC) of received signals based on transmit power according to some aspects. In the example shown in FIG. 5, a UE 500 includes a receiver AGC module (Rx AGC) 502 and a transmitter AGC module (Tx AGC) 504. The Rx AGC 502 may control the gain applied to a received signal (Rx) by applying a gain state (e.g., GS0, GS1, or GS2) to an LNA 506 of the receiver of the UE. The Tx AGC 504 may control the gain applied to a transmit signal (Tx) by applying a gain state (e.g., GS0, GS1, or GS2) to a PA 508 of the transmitter of the UE.

In various aspects, the Rx AGC 502 may dynamically adjust the gain state (e.g., analog gain applied to the Rx/LNA 506) in frequency bands with a small frequency separation between uplink and downlink frequencies by querying the Tx AGC 504 for an expected transmit power (e.g., transmit power level) in a next time element. For example, the next time element may correspond to a slot or a symbol in a slot. For example, the Rx AGC 502 may transmit a request 510 to the Tx AGC 504 for the expected transmit power in the next time element. In response, the Tx AGC 504 may provide the expected transmit power 512 to the Rx AGC 502.

The Rx AGC 502 may further maintain or access a transmit power threshold 514 and compare the expected transmit power 512 to the threshold 514. If the expected transmit power 512 exceeds the threshold 514, the Rx AGC 502 may enter a high Tx power mode of operation in which the Rx LNA 506 gain is reduced to avoid Rx saturation. As an example, the Rx AGC 502 may increase the LNA gain state from G0 to G1. In some examples, the high Tx power mode of operation may be implemented by modifying an estimated received signal strength indicator (RSSI) at the receive antenna. The estimated RSSI is used by the Rx AGC 502 to determine the LNA gain state. For example, by introducing a bias to the estimated RSSI, the Rx AGC 502 can switch to a lower gain state at a lower RSSI as compared to a regular mode of operation. In some examples, a hysteresis may further be added to the RSSI bias to avoid excessive toggling between gain states.

If the expected transmit power 512 is less than (or equal to) the threshold 514, the Rx AGC 502 may operate in the regular mode of operation and set the analog gain of the LNA 506 as normal for any other frequency band. For example, if the transmit power is less than (or equal to) the threshold 514, the Rx AGC 502 may set the analog gain (gain state) of the LNA 506 based on a receive power of the received signal (Rx). For example, the LNA gain state may be kept at gain state G0 to improve receiver performance (e.g., as compared to a higher gain state associated with lower analog gain) based on the receive power of the received signal.

In some examples, the Rx AGC 502 may query the Tx AGC 504 for the expected power level each slot or may query the Tx AGC 504 in one slot for the expected power level in the next N slots. In this example, the decision on whether to back-off the LNA (e.g., reduce the analog gain) may be made on a per-slot basis. Similarly, for symbol-level dynamic gain control, the Rx AGC 502 may query the Tx AGC 504 for the expected power level each symbol or may query the Tx AGC 504 in one symbol for the expected power level in the next N symbols. In this example, the decision on whether to back-off the LNA may be made on a per-symbol basis, provided that the receiver supports symbol-level LNA gain control.

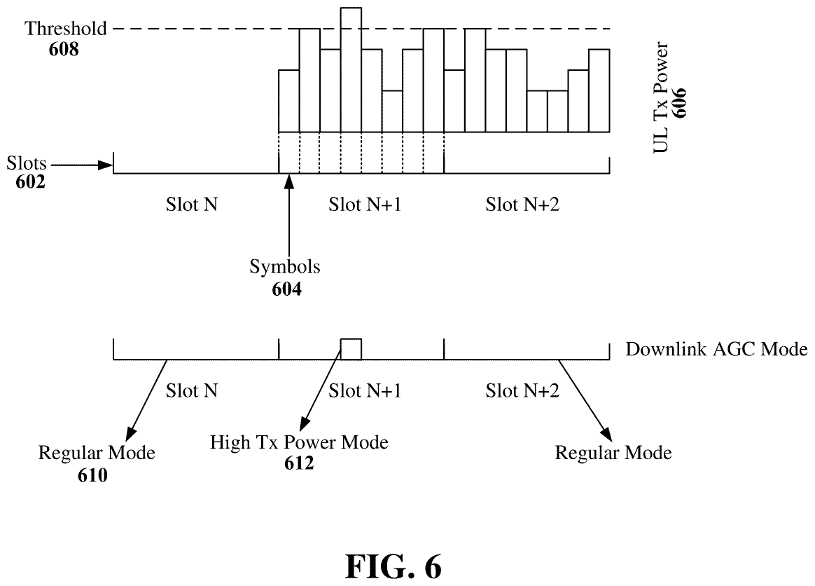

FIG. 6 is a diagram illustrating dynamic AGC modes based on transmit power according to some aspects. As shown in FIG. 6, the dynamic AGC mode in the downlink for the receiver may be set on a per-slot 602 basis or a per-symbol 604 basis. In each slot 602 (e.g., Slot N, Slot N+1, Slot N+2, etc.), the expected uplink transmit (Tx) power 606 is compared against a threshold 608. In the slots 602 and/or symbols 604 in which the expected transmit power 606 is less than (or equal to) the threshold 608, the Rx AGC operates in a regular downlink AGC mode in which the analog gain of the LNA is set based on the receive power of the received signal (e.g., without consideration for the Tx leakage power). However, in the slots 602 and/or symbols 604 in which the expected transmit power 606 is greater than (exceeds) the threshold 608, the Rx AGC operates in a high Tx power mode in which the analog gain of the LNA is modified based on the expected transmit power of the transmit signal (e.g., in consideration of the Tx leakage power).

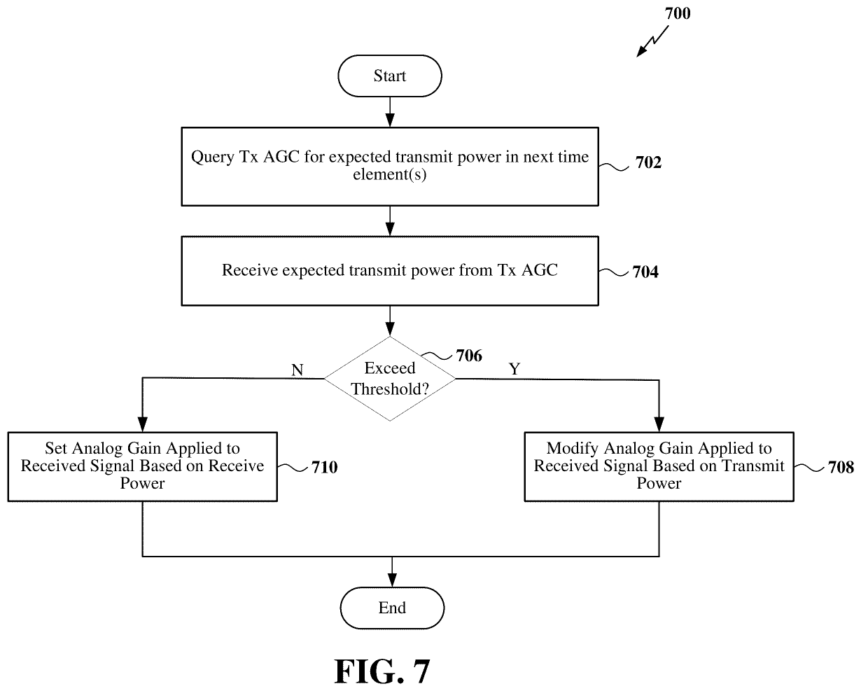

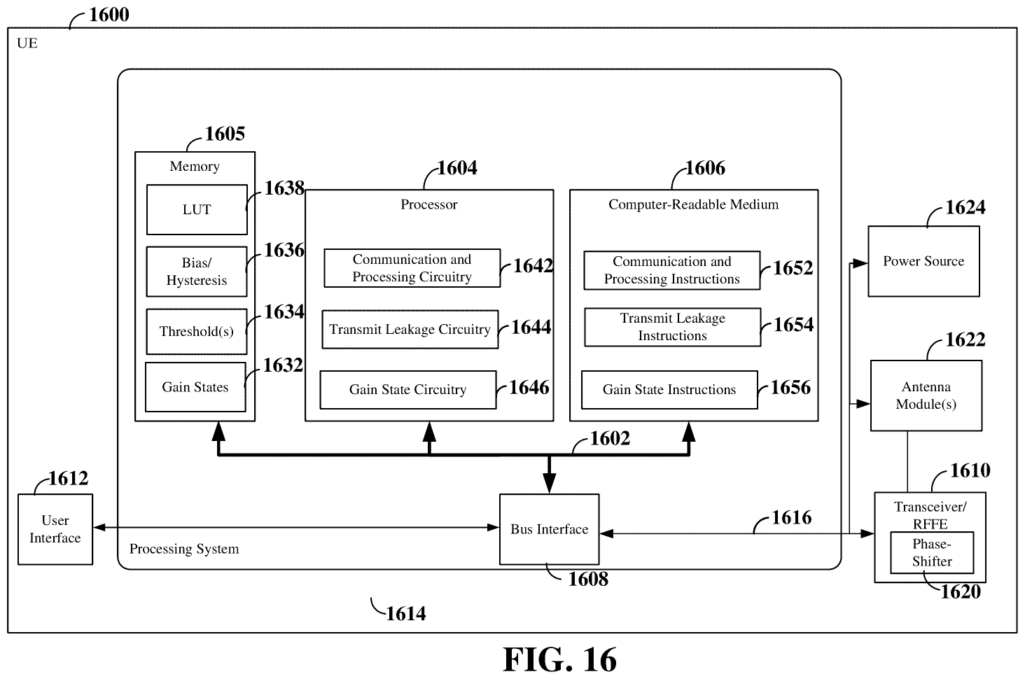

FIG. 7 is a flow chart illustrating an exemplary process 700 for dynamic AGC based on transmit power according to some aspects. As described below, some or all illustrated features may be omitted in a particular implementation within the scope of the present disclosure, and some illustrated features may not be required for implementation of all embodiments. In some examples, the process 700 may be carried out by the Rx AGC (receive AGC module) 502 illustrated in FIG. 5 and/or by the processor 1604 illustrated in FIG. 16. In some examples, the process 700 may be carried out by any suitable apparatus or means for carrying out the functions or algorithm described below.

At block 702, the Rx AGC may query the Tx AGC for the expected transmit power in a next time element. For example, the next time element may be a slot, a symbol, another unit of time. At block 704, the Rx AGC may receive the expected transmit power from the Tx AGC and compare the expected Tx AGC to a threshold.

At block 706, the Rx AGC determines whether the expected transmit power exceeds the threshold. If the expected transmit power exceeds the threshold (Y branch of block 706), at block 708, the Rx AGC modifies the analog gain applied to a received signal (e.g., modifies the LNA gain state) based on the transmit power. However, if the expected transmit power is less than or equal to the threshold (N branch of block 706), at block 710, the Rx AGC sets the analog gain applied to the received signal (e.g., sets the LNA gain state) based on the receive power of the received signal.

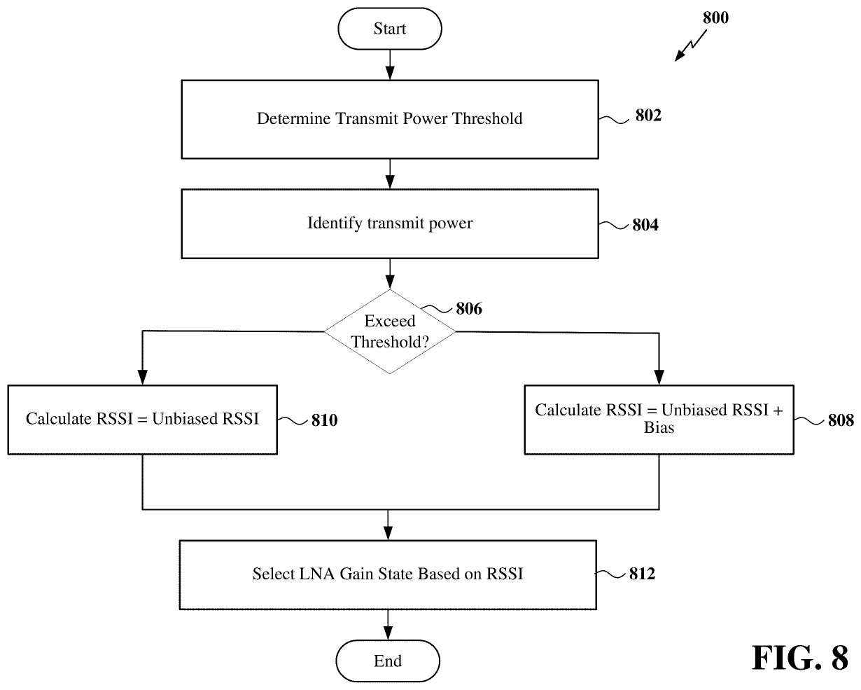

FIG. 8 is a flow chart illustrating another exemplary process 800 for dynamic AGC based on transmit power according to some aspects. As described below, some or all illustrated features may be omitted in a particular implementation within the scope of the present disclosure, and some illustrated features may not be required for implementation of all embodiments. In some examples, the process 800 may be carried out by the Rx AGC (receive AGC module) 502 of a receiver of a UE 500 illustrated in FIG. 5 and/or by the processor 1604 of a UE 1600 illustrated in FIG. 16. In some examples, the process 800 may be carried out by any suitable apparatus or means for carrying out the functions or algorithm described below.

At block 802, the Rx AGC may determine a transmit power threshold. For example, the transmit power threshold may be stored within the Rx AGC or within an external memory, register, or other storage unit. In some examples, the transmit power threshold may be a function of the frequency band and bandwidth of the uplink. As an example, a look-up table (LUT) may be provided that includes transmit power thresholds and corresponding uplink frequency bands/bandwidths.

In addition, at block 804, the Rx AGC may identify a transmit power of a transmit signal to be transmitted in a first frequency band. In some examples, the transmit power may be an expected transmit power of the transmit signal in a next time element (e.g., a slot or a symbol). For example, the Rx AGC may request the expected transmit power from a Tx AGC of a transmitter of the UE.

At block 806, the Rx AGC determines whether the transmit power exceeds the transmit power threshold. If the transmit power exceeds the transmit power threshold (Y branch of block 806), at block 808, the Rx AGC can calculate an estimated RSSI of a received signal received in a second frequency band (e.g., where a frequency separation between the first and second frequency bands is less than a frequency threshold) by adding a bias to an unbiased RSSI (e.g., Calculate RSSI=unbiased RSSI+bias). By adding the bias to the estimated RSSI, the selection of a lower gain state may be prevented, thereby avoiding saturation of RF receiver components. In some examples, a hysteresis may further be added to the bias to avoid excessive toggling between gain states.

However, if the transmit power is less than or equal to the transmit power threshold (N branch of block 806), at block 810, the Rx AGC can calculate the estimated RSSI without the added bias (e.g., Calculate RSSI=unbiased RSSI). At block 812, the Rx AGC can select and set the LNA gain state (e.g., G0, G1, or G2) based on the calculated RSSI (e.g., with or without bias).

However, using a static bias to force the Rx AGC to move to a higher gain state may not allow the Rx AGC to naturally switch to a lower gain state as the transmit leakage power decreases or when the transmit leakage power is less than expected. This may result in sensitivity and SNR degradation in the receiver. Therefore, various aspects are further directed towards maintaining separate estimates of the transmit leakage power (e.g., the Tx energy leaking into the Rx) and the receive power of the received signal (e.g., all other sources of energy seen in the Rx). By doing so, the Rx AGC can determine the optimal LNA gain state based on an estimate of the total RSSI without Tx leakage, thus leading to the best Rx performance. The Rx AGC can further determine whether an LNA gain state adjustment is needed to account for Tx leakage based on the estimate of the Tx interference.

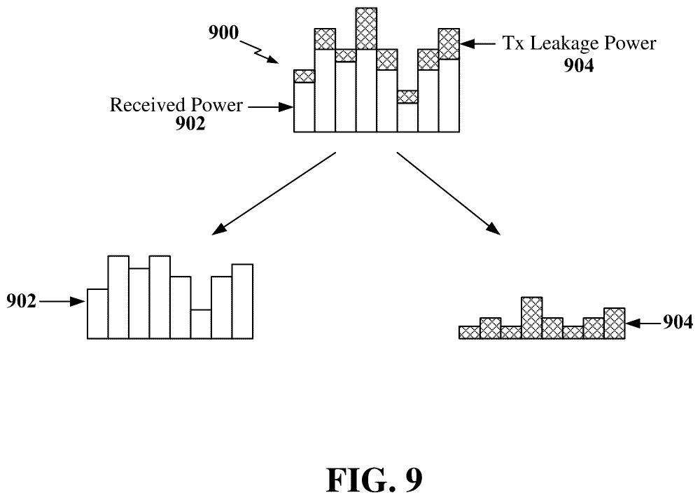

FIG. 9 is a diagram illustrating separation of receive power and transmit leakage power for AGC according to some aspects. In the example shown in FIG. 9, the total receive power 900 of a received signal on a receive frequency band of an FDD pair with small duplex separation includes both a receive power component 902 and a transmit (Tx) leakage power component 904. The Tx leakage component 904 may be a result of the transmit power of a transmitted signal on transmit frequency band of the FDD pair leaking into the receiver, as shown in the example of FIG. 2. The Tx leakage component 904 may be estimated using various mechanisms and canceled from the total receive power 900 to obtain the receive power component 902. For example, a total RSSI corresponding to the total receive power 900 may be measured at the receiver and an estimate of a transmit leakage RSSI corresponding to the Tx leakage component 904 may also be obtained by the receiver. The transmit leakage RSSI may then be subtracted from the total RSSI to produce a receive RSSI corresponding to the receive power component 902.

By maintaining separate estimates of the receive power component 902 and the transmit leakage power component 904, the Rx AGC may determine a respective gain state associated with each of the power components 902 and 904 and select the maximum gain state among the two gain states to apply to the LNA to prevent clipping/saturation of active RF components in the receiver chain when the Tx leakage power is high, while also optimizing the LNA gain state for the actual receive power level (e.g., total RSSI-Tx leakage RSSI). In addition, by maintaining separate estimates, separate operating setpoints (e.g., back-offs from the ADC saturation point) may further be maintained for each of the two power components 902 and 904. The operating setpoints represent the amount of headroom to be applied to the RSSI to prevent ADC saturation. The headroom accounts for time domain waveform fluctuations (e.g., peak-to-average-power ratio (PAPR)) and variations caused by the wireless environment, and as such, prevents the ADC from saturating as a result of these variations.

In some examples, different operating setpoints may be set for each of the power components 902 and 904. For example, if the saturation point of the ADC is zero dB, the operating setpoint (e.g., headroom) of the receive power component 902 may be −18 dBFS (dB relative to full scale), whereas the operating setpoint (e.g., headroom) of the Tx leakage power component 904 may be −7 dBFS. Less headroom may be applied to the Tx leakage power component 904 because the Tx leakage power is not subject to a fading environment, path loss, or other variations in the signal caused by the wireless channel (e.g., the Tx leakage power is not transmitted, but rather fed back into the receiver). Since the receive power component 902 is subjected to variations in the wireless channel, additional headroom may be added to the receive power component 902 to avoid saturation of the ADC due to changes in the wireless environment.

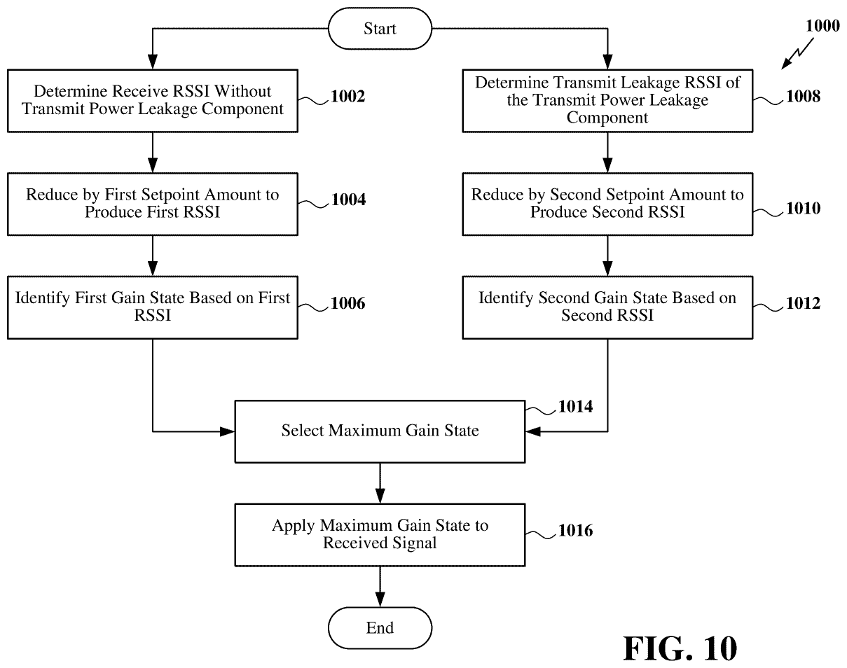

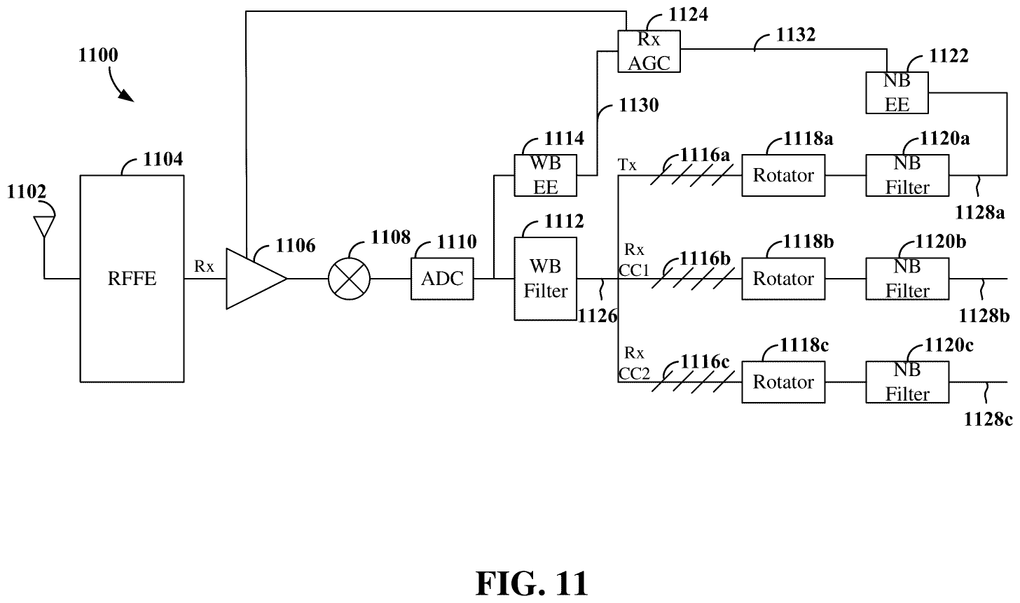

FIG. 10 is a flow chart illustrating an exemplary process 1000 for dynamic AGC based on both the receive power and the transmit power leakage according to some aspects. As described below, some or all illustrated features may be omitted in a particular implementation within the scope of the present disclosure, and some illustrated features may not be required for implementation of all embodiments. In some examples, the process 1000 may be carried out by the Rx AGC 502 of the UE 500 illustrated in FIG. 5, the UE 1100 illustrated in FIG. 11, and/or by the processor 1604 of the UE 1600 illustrated in FIG. 16. In some examples, the process 1000 may be carried out by any suitable apparatus or means for carrying out the functions or algorithm described below.

At block 1002, on the left branch of the flowchart, the UE may determine a receive RSSI of a received signal without a transmit power leakage component. For example, the instantaneous estimate of the residual power at the Rx antenna after removing the contribution of the Tx leakage power may be filtered to obtain a time-averaged estimate of the receive power level (e.g., the receive RSSI). At block 1004, the receive RSSI may be reduced by a first setpoint amount to produce a first RSSI. In some examples, the first setpoint amount (e.g., ADC setpoint) may be set around 20 dB below the full-scale (FS) value (e.g., ADC saturation point). 20 dB may provide sufficient margin for power fluctuations due to PAPR fluctuations and/or fading in the wireless environment. At block 1006, the Rx AGC identifies a first gain state based on the first RSSI. For example, the Rx AGC uses the first RSSI to determine the optimal gain state to ensure the signal level at the input of the ADC is close to the desired target level (e.g., the operating setpoint).

In addition, at block 1008, on the right branch of the flowchart, the UE may determine a transmit leakage RSSI of the transmit power leakage component. For example, the UE may determine the instantaneous Tx power leaking into the Rx. At block 1010, the transmit leakage RSSI may be reduced by a second setpoint amount to produce a second RSSI. In some examples, the second setpoint amount is different than the first setpoint amount. For example, the first setpoint amount may be −18 dBFS, whereas the second setpoint amount may be −7 dBFS. The second setpoint amount may be less than the first setpoint amount since the PAPR of the transmit signal is known and should be less than the second setpoint amount and there is no fluctuation in the transmit leakage power due to fading, so less margin from ADC saturation is needed. At block 1012, the Rx AGC identifies a second gain state based on the second RSSI. For example, the Rx AGC uses the second RSSI to determine the optimal gain state to ensure the signal level at the input of the ADC is close to the desired target level (e.g., the operating setpoint).

At block 1014, in the common branch of the flowchart, the Rx AGC selects the maximum gain state between the first gain state and the gain state. In addition, at block 1016, the Rx AGC applies the maximum gain state to the received signal (e.g., sets the LNA gain using the maximum gain state). For example, if the first gain state is G1 and the second gain state is G0, the Rx AGC can select the first gain state (G1). For example, the received signal may be strong and the transmit leakage power may be low, thus causing the Rx AGC to select the LNA gain state corresponding to the first RSSI associated with the receive power component. However, if the first gain state is G0 and the second gain state is G1, the Rx AGC can select the second gain state (G1). For example, the received signal may be weak (e.g., the received signal may be noise dominated) and the transmit leakage power may be high, thus causing the Rx AGD to select the LNA gain state corresponding to the second RSSI associated with the transmit leakage power component.

FIG. 11 is a diagram illustrating an example of energy estimation of the receive power and the transmit power leakage according to some aspects. In the example shown in FIG. 11, a UE 1100 includes a radio frequency front end (RFFE) 1104 coupled to an antenna module 1102 (e.g., one or more antenna modules, each corresponding to an antenna panel or antenna array). The RFFE 1104 is coupled to a receiver for receiving a received signal (Rx) from the RFFE 1104. The receiver includes a low noise amplifier (LNA) 1106, mixer 1108 (e.g., down-conversion module), and an analog-to-digital converter (ADC) 1110. The output of the ADC is fed to a wideband filter 1112 (WB Filter) configured to capture a wideband signal 1126 sampled at the same sampling rate as the ADC 1110. With carrier aggregation, for example, the sampling rate can be set high enough to capture the signal from all of the carrier components. In general, the wideband filter 1112 is set at a high sampling rate to capture a wide frequency range of the received signal.

In addition, the output of the ADC 1110 may further be input to a wideband energy estimation module (WB EE) 1114 to estimate the total RSSI 1130 of the wideband signal 1126. As described above, the total RSSI 1130 includes the Tx leakage power component. Thus, the wideband signal 1126 includes both the receive power of the intended received signal and the Tx leakage power component.

The wideband signal 1126 may further be fed to a plurality of narrowband receive chains (three of which are shown for convenience), each including a respective decimator 1116a, 1116b, and 1116c, respective rotator 1118a, 1118b, and 1118c, and respective narrowband filter 1120a, 1120b, and 1120c. The decimators 1116a, 1116b, and 1116c are each configured to reduce the sampling rate to isolate respective narrowband signals, each at a different component carrier (e.g., Rx CC1 and Rx CC2). The rotators 1118a, 1118b, and 1118c are each configured to rotate, shift, or otherwise re-center the corresponding narrowband signal in frequency (e.g., re-center around the DC point of the narrowband receiver). For example, with carrier aggregation, the signal of different component carriers (e.g., Rx CC1 and Rx CC2) may be separated out from the same wideband signal 1126 by setting different center point frequencies at each of the rotators 1118a, 1118b, and 1118c. In addition, the narrowband filters 1120a, 1120b, and 1120c (e.g., low pass filters) are configured to filter the corresponding re-centered/rotated signals to reduce the frequency range of the corresponding signals and produce respective narrowband signals 1128a, 1128b, and 1128c that may be further processed (not shown).

In various aspects, one of the narrowband receive chains may be used to isolate and rotate the transmit signal (Tx) out of the wideband signal 1126 to capture the transmit leakage power component. For example, the first receive chain shown in FIG. 11 including decimator 1116a, rotator 1118a, and NB filter 1120a may be utilized to capture the Tx signal (e.g., as narrowband signal 1128a), which may further be fed to a narrowband energy estimation module (NB EE) 1122 to estimate the transmit leakage RSSI 1132.

The total RSSI 1130 and the transmit leakage RSSI 1132 may then be fed to a receiver automatic gain control module (Rx AGC) 1124. The Rx AGC 1124 may be configured to calculate a receive RSSI based on the total RSSI 1130 and the transmit leakage RSSI 1132. For example, the Rx AGC 1124 may be configured to remove the transmit leakage RSSI 1132 from the total RSSI 1130 to produce the receive RSSI and to further reduce the receive RSSI by a first setpoint amount to produce a first RSSI. In addition, the Rx AGC 1124 may be configured to reduce the transmit leakage RSSI by a second setpoint amount to produce a second RSSI. The RX AGC 1124 may then be configured to identify respective gain states associated with the first and second RSSI and select the maximum gain state therefrom to set the gain of the LNA 1106.

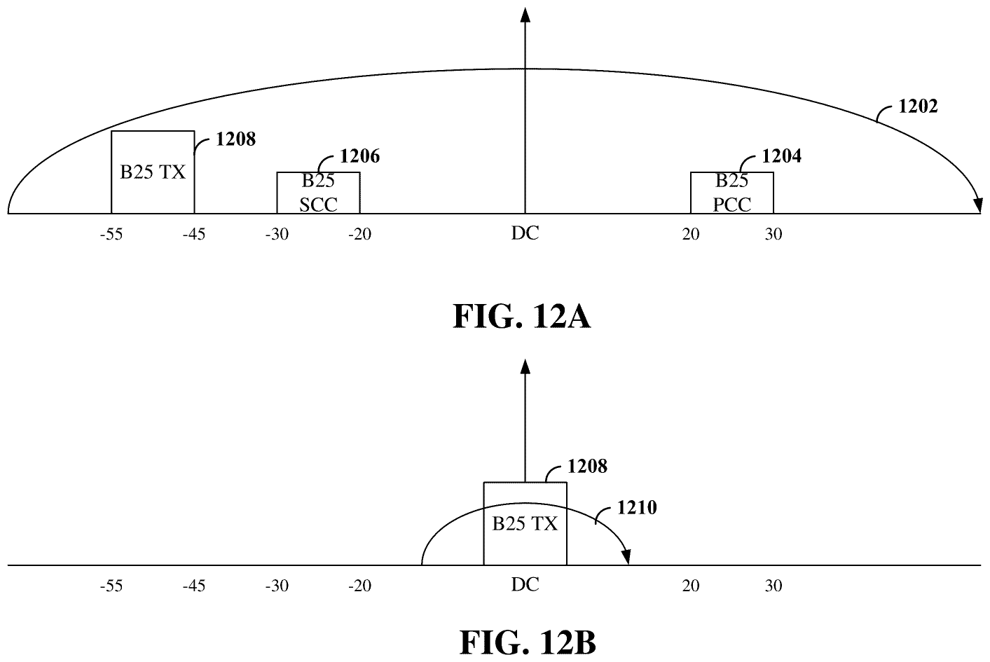

FIGS. 12A and 12B are diagrams illustrating an example of energy estimation of the transmit power leakage according to some aspects. In the example shown in FIG. 12A, a wideband signal 1202 may be captured by the ADC and wideband filter shown in FIG. 11 that includes two component carriers in FDD band B25 (e.g., B25 primary component carrier (PCC) 1204 and B25 secondary component carrier (SCC) 1206). In addition, the wideband signal 1202 further includes a Tx leakage component (B25 Tx) 1208 of a transmit signal in the FDD band pair. The Tx leakage component 1208 may be captured, for example, by increasing the sampling rate of the ADC 1110 shown in FIG. 11. In addition, the poles of the wideband filter 1112 shown in FIG. 11 may further be tuned such that the Tx leaked signal falls in-band and can be received with minimal droop (e.g., attenuation due to the wideband filter). As shown in FIG. 12B, after re-centering the Tx leakage component 1208 around the Tx center frequency through the rotator (e.g., rotator 1118a) shown in FIG. 11 to produce a narrowband Tx signal 1210, the Tx energy can be estimated by, for example, the NB EE 1122 shown in FIG. 11.

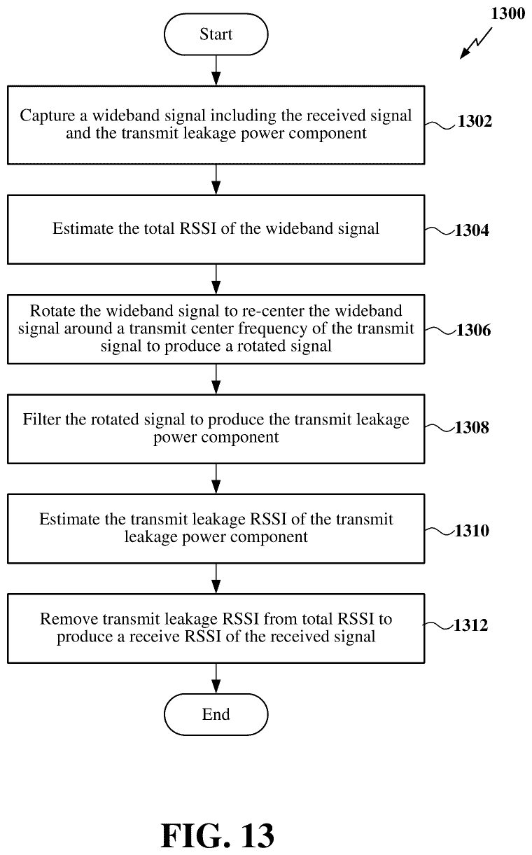

FIG. 13 is a flow chart illustrating an exemplary process 1300 for energy estimation of the transmit power leakage according to some aspects. As described below, some or all illustrated features may be omitted in a particular implementation within the scope of the present disclosure, and some illustrated features may not be required for implementation of all embodiments. In some examples, the process 1300 may be carried out by the Rx AGC 502 of the UE 500 illustrated in FIG. 5, the UE 1100 illustrated in FIG. 11, and/or by the processor 1604 of the UE 1600 illustrated in FIG. 16. In some examples, the process 1300 may be carried out by any suitable apparatus or means for carrying out the functions or algorithm described below.

At block 1302, the UE may capture a wideband signal including the received signal (e.g., the intended received signal without transmit leakage) and the transmit leakage power component. For example, the UE may increase a sampling rate of an ADC to capture the wideband signal and tune a filter (e.g., wideband filter) of the receiver of the UE to include the transmit leakage power component.

At block 1304, the UE may estimate a total RSSI of the wideband signal (e.g., the received signal with the transmit leakage power component). For example, the wideband signal may be fed to a wideband energy estimation module 1114, as shown in FIG. 11, to estimate the total RSSI of the wideband signal.

At block 1306, the UE may rotate the wideband signal to re-center the wideband signal around a transmit center frequency of the transmit signal to produce a rotated signal. The rotated signal may correspond to a narrowband signal isolated by a decimator and rotated by a rotator, as shown in FIG. 11.

At block 1308, the UE may filter the rotated signal to produce the transmit leakage power component. In addition, at block 1310, the UE may estimate the transmit leakage RSSI of the transmit leakage power component. For example, the transmit leakage power component may be fed to a narrowband energy estimation module 1122, as shown in FIG. 11, to estimate the transmit leakage RSSI. At block 1312, the UE may then remove the transmit RSSI from the total RSSI to produce a receive RSSI of the received signal. The receive RSSI and the transmit leakage RSSI may then be used to identify a gain state for the LNA, as described above.

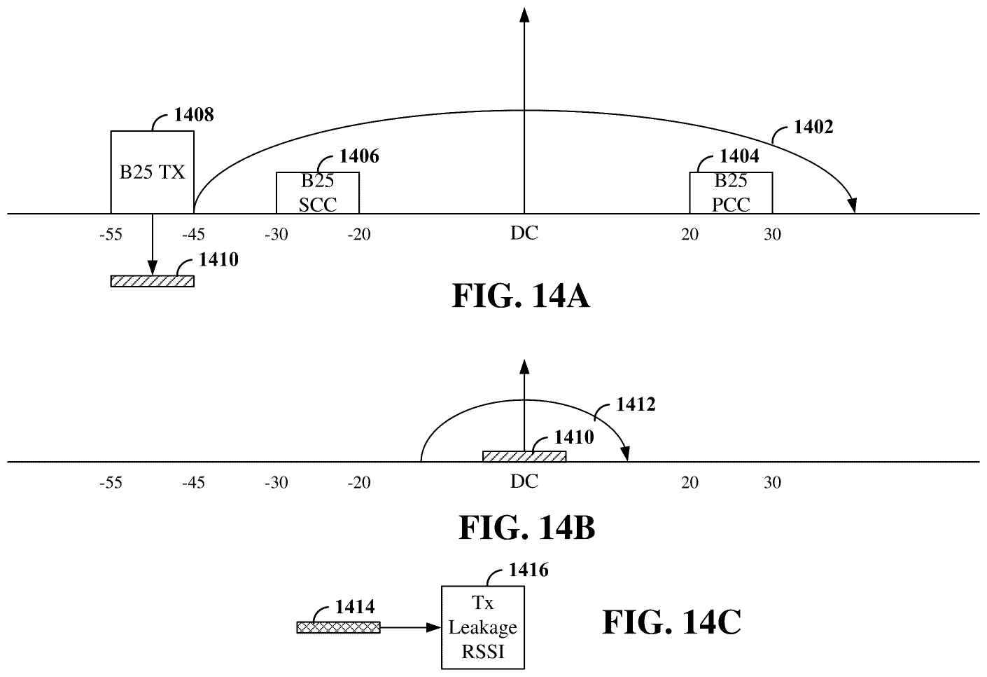

FIGS. 14A-14C are diagrams illustrating another example of energy estimation of the transmit power leakage according to some aspects. In the example shown in FIG. 14A, a wideband signal 1402 may be captured by the ADC and wideband filter shown in FIG. 11 that includes two component carriers in FDD band B25 (e.g., B25 primary component carrier (PCC) 1204 and B25 secondary component carrier (SCC) 1206). However, the wideband signal 1402 does not include the Tx leakage component (B25 Tx) 1408 of the transmit signal in the FDD band pair. For example, the poles of the wideband filter 1112 shown in FIG. 11 may be tuned such that the Tx leaked signal falls out-of-band and therefore is passed with significant droop (e.g., attenuation 1410 due to the wideband filter). In this example, the sampling rate of the ADC is maintained at a normal sampling rate (e.g., the same sampling rate as for any other frequency band without leakage). For example, the sampling rate of the ADC may be set to capture the received signal in the B25 receive frequency band, including the PCC 1204 and SCC 1206. This reduction in sampling rate reduces the ADC power as compared to the power required to operate the ADC at a higher sampling rate.

As shown in FIG. 14B, after re-centering the Tx leakage component 1408 around the Tx center frequency through the rotator (e.g., rotator 1118a) shown in FIG. 11, an attenuated version 1410 of the transmit leakage power component is produced within a narrowband signal 1412. As shown in FIG. 14C, the Tx energy of the attenuated version 1410 of the Tx leakage power may then be estimated to produce an attenuated RSSI 1414 using, for example, the NB EE 1122 shown in FIG. 11. Since the filter response of the wideband filter is known, the attenuation may be compensated by scaling the attenuated RSSI 1414 to produce the transmit leakage RSSI 1416. For example, from the estimate of the attenuated RSSI 1414 and the known filter response, the Rx AGC can predict the amount of energy spilling into the in-band component due to aliasing. A look-up table or other mechanism may be used to determine the scaling factor to apply to the attenuated RSSI 1414 to produce the transmit leakage RSSI 1416. For example, a look-up table mapping the scaling factor to the attenuated RSSI based on the frequency separation between the downlink and uplink FDD pair may be used to determine the scaling factor. For example, the scaling factor may be determined based on a filter response of the receiver. Since the filter response may be known, the scaling factor as a function of the frequency separation may be pre-computed, for example, offline and stored in a look-up table in memory.

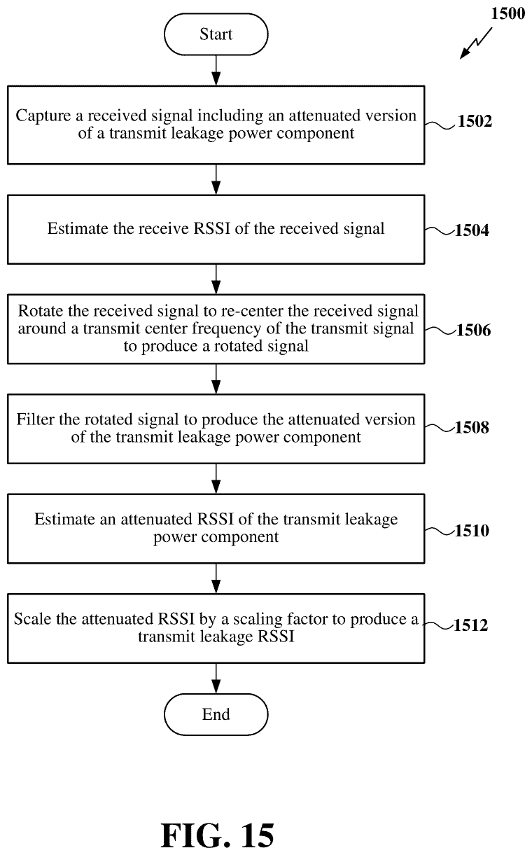

FIG. 15 is a flow chart illustrating another exemplary process 1500 for energy estimation of the transmit power leakage according to some aspects. As described below, some or all illustrated features may be omitted in a particular implementation within the scope of the present disclosure, and some illustrated features may not be required for implementation of all embodiments. In some examples, the process 1500 may be carried out by the Rx AGC 502 of the UE 500 illustrated in FIG. 5, the UE 1100 illustrated in FIG. 11, and/or by the processor 1604 of the UE 1600 illustrated in FIG. 16. In some examples, the process 1500 may be carried out by any suitable apparatus or means for carrying out the functions or algorithm described below.

At block 1502, the UE may capture a received signal including an attenuated version of a transmit leakage power component. For example, the UE may use a normal sampling rate of an ADC and tune a filter (e.g., wideband filter) of the receiver of the UE such that the transmit leakage power component is out-of-band to capture the received signal including the attenuated version of the transmit leakage power component.

At block 1504, the UE may estimate a receive RSSI of the received signal. For example, the received signal may be fed to a wideband energy estimation module 1114, as shown in FIG. 11, to estimate the receive RSSI of the received signal.

At block 1506, the UE may rotate the received signal to re-center the wideband signal around a transmit center frequency of the transmit signal to produce a rotated signal. The rotated signal may correspond to a narrowband signal isolated by a decimator and rotated by a rotator, as shown in FIG. 11.

At block 1508, the UE may filter the rotated signal to produce the attenuated version of the transmit leakage power component. In addition, at block 1510, the UE may estimate an attenuated RSSI of the transmit leakage power component. For example, the attenuated version of the transmit leakage power component may be fed to a narrowband energy estimation module 1122, as shown in FIG. 11, to estimate the attenuated RSSI. At block 1512, the UE may then scale the attenuated RSSI by a scaling factor to produce a transmit leakage RSSI. For example, the UE may access a look-up table (LUT) mapping the scaling factor to the attenuated RSSI based on the frequency separation and a filter response (e.g., wideband filter response) of the receiver. The receive RSSI and the transmit leakage RSSI may then be used to identify a gain state for the LNA, as described above.

FIG. 16 is a block diagram illustrating an example of a hardware implementation of a user equipment (UE) 1600 employing a processing system 1614 according to some aspects. For example, the UE 1600 may correspond to any of the UEs shown and described above in reference to FIGS. 1, 2, 5 and/or 11.

In accordance with various aspects of the disclosure, an element, or any portion of an element, or any combination of elements may be implemented with a processing system 1614 that includes one or more processors, such as processor 1604. Examples of processors 1604 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the UE 1600 may be configured to perform any one or more of the functions described herein. That is, the processor 1604, as utilized in the UE 1600, may be used to implement any one or more of the methods or processes described herein.

The processor 1604 may in some instances be implemented via a baseband or modem chip and in other implementations, the processor 1604 may include a number of devices distinct and different from a baseband or modem chip (e.g., in such scenarios as may work in concert to achieve examples discussed herein). And as mentioned above, various hardware arrangements and components outside of a baseband modem processor can be used in implementations, including RF-chains, power amplifiers, modulators, buffers, interleavers, adders/summers, etc.

In this example, the processing system 1614 may be implemented with a bus architecture, represented generally by the bus 1602. The bus 1602 may include any number of interconnecting buses and bridges depending on the specific application of the processing system 1614 and the overall design constraints. The bus 1602 communicatively couples together various circuits, including one or more processors (represented generally by the processor 1604), one or more memories (represented generally by the memory 1605), and one or more computer-readable media (represented generally by the computer-readable medium 1606). In some examples, the computer-readable media 1606 may be included within or part of one or more of the memories 1605. The bus 1602 may also link various other circuits such as timing sources, peripherals, voltage regulators, and power management circuits, which are well known in the art, and therefore, are not described any further.

A bus interface 1608 provides an interface between the bus 1602, one or more transceivers/RFFEs 1610, and one or more antenna modules (e.g., one or more antenna arrays or panels) 1622. The transceiver 1610 and antenna module(s) 1622 provides a means for communicating with various other apparatus over a transmission medium (e.g., air interface. The bus interface 1608 further provides an interface between the bus 1602 and a power source 1624 (e.g., a battery). The bus interface 1608 further provides an interface between the bus 1602 and a user interface 1612 (e.g., keypad, display, touch screen, speaker, microphone, control features, etc.). Of course, such a user interface 1612 may be omitted in some examples.

The computer-readable medium 1606 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 1606 may reside in the processing system 1614, external to the processing system 1614, or distributed across multiple entities including the processing system 1614. The computer-readable medium 1606 may be embodied in a computer program product. By way of example, a computer program product may include a computer-readable medium in packaging materials. In some examples, the computer-readable medium 1606 may be part of the memory 1605. Those skilled in the art will recognize how best to implement the described functionality presented throughout this disclosure depending on the particular application and the overall design constraints imposed on the overall system. In some examples, the computer-readable medium 1606 may be implemented on an article of manufacture, which may further include one or more other elements or circuits, such as the processor 1604 and/or memory 1605.

The computer-readable medium 1606 may store computer-executable code (e.g., software). Software shall be construed broadly to mean instructions, instruction sets, code, code segments, program code, programs, subprograms, software modules, applications, software applications, software packages, routines, subroutines, objects, executables, threads of execution, procedures/processes, functions, etc., whether referred to as software, firmware, middleware, microcode, hardware description language, or otherwise.

One or more processors, such as processor 1604, may be responsible for managing the bus 1602 and general processing, including the execution of the software (e.g., instructions or computer-executable code) stored on the computer-readable medium 1606. The software, when executed by the processor 1604, causes the processing system 1614 to perform the various processes and functions described herein for any particular apparatus. The computer-readable medium 1606 and/or the memory 1605 may also be used for storing data that may be manipulated by the processor 1604 when executing software. For example, the memory 1605 may store one or more of gain states 1632, threshold(s) 1634, and bias/hysteresis values 1636. In some examples, the memory 1605 may further store a LUT 1638 including scaling factors and attenuated RSSIs.

In some aspects of the disclosure, the processor 1604 may include circuitry configured for various functions. For example, the processor 1604 may include communication and processing circuitry 1642 configured to communicate with one or more UEs and/or one or more network entities. In some examples, the communication and processing circuitry 1642 may include one or more hardware components that provide the physical structure that performs processes related to wireless communication (e.g., signal reception and/or signal transmission) and signal processing (e.g., processing a received signal and/or processing a signal for transmission). For example, the communication and processing circuitry 1642 may include one or more transmit/receive chains.

In some implementations where the communication involves receiving information, the communication and processing circuitry 1642 may obtain information from a component of the UE 1600 (e.g., from the transceiver 1610 that receives the information via radio frequency signaling or some other type of signaling suitable for the applicable communication medium), process (e.g., decode) the information, and output the processed information. For example, the communication and processing circuitry 1642 may output the information to another component of the processor 1604, to the memory 1605, or to the bus interface 1608. In some examples, the communication and processing circuitry 1642 may receive one or more of signals, messages, other information, or any combination thereof. In some examples, the communication and processing circuitry 1642 may receive information via one or more channels. In some examples, the communication and processing circuitry 1642 may include functionality for a means for receiving. In some examples, the communication and processing circuitry 1642 may include functionality for a means for processing, including a means for demodulating, a means for decoding, etc.

In some implementations where the communication involves sending (e.g., transmitting) information, the communication and processing circuitry 1642 may obtain information (e.g., from another component of the processor 1604, the memory 1605, or the bus interface 1608), process (e.g., modulate, encode, etc.) the information, and output the processed information. For example, the communication and processing circuitry 1642 may output the information to the transceiver 1610 (e.g., that transmits the information via radio frequency signaling or some other type of signaling suitable for the applicable communication medium). In some examples, the communication and processing circuitry 1642 may send one or more of signals, messages, other information, or any combination thereof. In some examples, the communication and processing circuitry 1642 may send information via one or more channels. In some examples, the communication and processing circuitry 1642 may include functionality for a means for sending (e.g., a means for transmitting). In some examples, the communication and processing circuitry 1642 may include functionality for a means for generating, including a means for modulating, a means for encoding, etc.

In some examples, the communication and processing circuitry 1642 may be configured to receive and process downlink (received) signals, which may be, for example, beamformed signals at a mmWave frequency or a sub-6 GHz frequency via the transceiver 1610 and the antenna module(s) 1622 (e.g., using a phase-shifter 1620). In addition, the communication and processing circuitry 1642 may be configured to generate and transmit uplink (transmit) signals, which may be, for example, beamformed signals at a mmWave frequency or a sub-6 GHz frequency via the transceiver 1610 and antenna module(s) 1622 (e.g., using the phase-shifter 1620).

In some examples, the communication and processing circuitry 1642 may be configured to transmit the transmit (uplink) signal in a first frequency band and to receive the received (downlink) signal in a second frequency band. In some examples, a frequency separation between the first frequency band and the second frequency band may be less than a first threshold (e.g., one of the threshold(s) 1634 maintained in the memory 1605). In addition, the communication and processing circuitry 1642 may be configured to transmit the transmit (uplink) signal at a transmit power (e.g., using the power source 1624) and receive the received signal at a receive power. The communication and processing circuitry 1642 may further be configured to execute communication and processing software 1652 stored on the computer-readable medium 1606 to implement one or more functions described herein.

The processor 1604 may further include transmit leakage circuitry 1644, configured to identify the transmit power of the transmit signal and/or a transmit leakage power component of the received signal corresponding to a portion of the transmit power leaking into the received signal. In some examples, the transmit leakage circuitry 1644 may be configured to identify the transmit power as an expected transmit power in a next time element. For example, the next time element may be a slot or a symbol. In some examples, the transmit leakage circuitry 1644 is included within an AGC module of a receiver of the UE 1600 (e.g., the receive (Rx) AGC shown in FIG. 2 and/or FIG. 5). In this example, the transmit leakage circuitry 1644 may be configured to request the expected transmit power from a transmit (Tx) AGC module of a transmitter of the UE 1600.

In some examples, the transmit leakage circuitry 1644 may include the WB EE 1114 and NB EE 1122 shown in FIG. 11. For example, the transmit leakage circuitry 1644 may be configured to estimate both a total RSSI including the received signal and the transmit leakage power component and to estimate a transmit leakage RSSI of the transmit leakage power component. In this example, the transmit leakage circuitry may be configured to capture a wideband signal including the received signal and the transmit leakage power component, rotate the wideband signal to re-center the wideband signal around a transmit center frequency of the transmit signal to produce a rotated signal, filter the rotated signal to produce the transmit leakage power component, and estimate the transmit leakage RSSI of the transmit leakage power component. For example, the transmit leakage circuitry 1644 may be configured to increase a sampling rate of an ADC in the receiver of the UE to capture the wideband signal and tune a filter of the receiver to include the transmit leakage power component.

As another example, the transmit leakage circuitry 1644 may be configured to capture the received signal including an attenuated version of the transmit leakage power component, rotate the received signal to re-center the received signal around a transmit center frequency of the transmit signal to produce a rotated signal, filter the rotated signal to produce the attenuated version of the transmit leakage power component, and estimate an attenuated RSSI of the transmit leakage power component. The attenuated RSSI may then be scaled by a scaling factor, as described below, to produce the transmit leakage RSSI. In this example, the transmit leakage circuitry 1644 may be configured to set a sampling rate of the ADC to capture the received signal in the second frequency band and to filter the received signal to produce the attenuated version of the transmit leakage power component. The transmit leakage circuitry 1644 may further be configured to execute transmit leakage instructions (software) 1654 stored on the computer-readable medium 1606 to implement one or more functions described herein.

The processor 1604 may further include gain state circuitry 1646, configured to modify an analog gain applied to the received signal based on the transmit power. In some examples, the gain state circuitry 1646 may include the Rx AGC module shown in FIG. 2, FIG. 5, and/or FIG. 11. For example, the gain state circuitry 1646 may be configured to determine whether the frequency separation between the first frequency band of the transmit signal and the second frequency band of the received signal is less than the first threshold (e.g., one of the threshold(s) 1634 maintained in memory), and if so, modify the analog gain applied to the received signal based on the transmit power.

In some examples, the gain state circuitry 1646 may be configured to modify the analog gain in response to the transmit power being greater than a second threshold (e.g., one of the threshold(s) 1634 maintained in memory 1605). For example, the gain state circuitry 1646 may be configured to increase a gain state 1632 of a low noise amplifier (LNA) in the transceiver 1610 in response to the transmit power being greater than the second threshold 1634. In some examples, the gain state circuitry 1646 may be configured to set the analog gain applied to the received signal based on a receive power of the received signal in response to the transmit power being less than the second threshold 1634. In some examples, the gain state circuitry 1646 may be configured to modify an estimated receive signal strength indicator (RSSI) of the received signal to produce a modified estimated RSSI in response to the transmit power being greater than the second threshold 1634 and to determine a gain state 1632 of a low noise amplifier (LNA) of a receiver of the UE based on the modified estimated RSSI. For example, the gain state circuitry 1646 may be configured to modify the estimated RSSI by adding a static bias 1636 to the estimated RSSI to produce the modified estimated RSSI. In some examples, the gain state circuitry 1646 may further be configured to add a hysteresis to the static bias (bias+hysteresis 1636) to produce the modified estimated RSSI.

In some examples, the gain state circuitry 1646 may be configured to estimate a first RSSI of the received signal without a transmit leakage component corresponding to a portion of the transmit power leaking into the received signal, identify a first gain state to be applied to the received signal based on the first RSSI, estimate a second RSSI of the transmit leakage component, identify a second gain state to be applied to the received signal based on the second RSSI, and select a maximum gain state between the first gain state and the second gain state to apply to the received signal.

For example, the gain state circuitry 1646 may be configured to receive the total RSSI and the transmit leakage RSSI from the transmit leakage circuitry 1644. The gain state circuitry 1646 may then be configured to remove the transmit leakage RSSI of the transmit leakage power component from the total RSSI to produce a receive RSSI and to further reduce the receive RSSI by a first setpoint amount of an analog-to-digital (ADC) in a receiver of the UE to produce the first RSSI, wherein the first setpoint amount is associated with the receive RSSI. In addition, the gain state circuitry 1646 may be configured to reduce the transmit leakage RSSI by a second setpoint amount of the ADC associated with the transmit leakage RSSI to produce the second RSSI.

In some examples, the gain state circuitry 1646 may be configured to scale the attenuated RSSI by the scaling factor to produce the transmit leakage RSSI. For example, the gain state circuitry 1646 may be configured to access the LUT 1638 mapping the scaling factor to the attenuated RSSI based on the frequency separation between the transmit signal and the received signal. The gain state circuitry 1646 may further be configured to execute gain state instructions (software) 1656 stored on the computer-readable medium 1606 to implement one or more functions described herein.

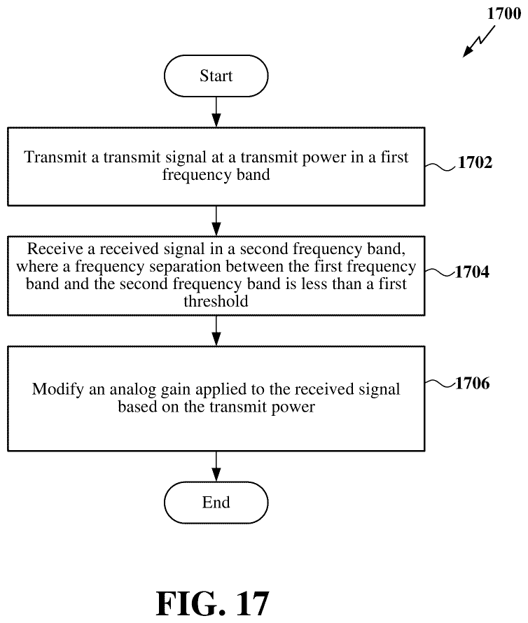

FIG. 17 is a flow chart illustrating an exemplary process 1700 for dynamic AGC based on transmit power according to some aspects. As described below, some or all illustrated features may be omitted in a particular implementation within the scope of the present disclosure, and some illustrated features may not be required for implementation of all embodiments. In some examples, the process 1700 may be carried out by the UE 1600 illustrated in FIG. 16. In some examples, the process 1700 may be carried out by any suitable apparatus or means for carrying out the functions or algorithm described below.

At block 1702, the UE may transmit a transmit signal at a transmit power in a first frequency band. For example, the communication and processing circuitry 1642, together with the transceiver 1610, antenna module(s) 1622, and power source 1624, shown and described above in connection with FIG. 16 may provide a means to transmit the transmit signal.

At block 1704, the UE may receive a received signal in a second frequency band, where a frequency separation between the first frequency band and the second frequency band is less than a first threshold. For example, the communication and processing circuitry 1642, together with the transceiver 1610, antenna module(s) 1622, and power source 1624, shown and described above in connection with FIG. 16 may provide a means to receive the received signal.

At block 1706, the UE may modify an analog gain applied to the received signal based on the transmit power. For example, the transmit leakage circuitry 1644, gain state circuitry 1646, and transceiver 1610, shown and described above in connection with FIG. 16 may provide a means to modify the analog gain.

In one configuration, the UE includes means for transmitting a transmit signal at a transmit power in a first frequency band, means for receiving a received signal in a second frequency band, wherein a frequency separation between the first frequency band and the second frequency band is less than a first threshold, and means for modifying an analog gain applied to the received signal based on the transmit power. In one aspect, the aforementioned means may be the processor 1604 shown in FIG. 11 configured to perform the functions recited by the aforementioned means. In another aspect, the aforementioned means may be a circuit or any apparatus configured to perform the functions recited by the aforementioned means.

Of course, in the above examples, the circuitry included in the processor 1604 is merely provided as an example, and other means for carrying out the described functions may be included within various aspects of the present disclosure, including but not limited to the instructions stored in the computer-readable storage medium 1606, or any other suitable apparatus or means described in any one of the FIGS. 1, 2, 5, 11, and/or 16, and utilizing, for example, the processes and/or algorithms described herein in relation to FIGS. 7, 8, 10, 13, 15, and 17.

The following provides an overview of aspects of the present disclosure:

Aspect 1: A method operable at a user equipment (UE), the method comprising: transmitting a transmit signal at a transmit power in a first frequency band; receiving a received signal in a second frequency band, wherein a frequency separation between the first frequency band and the second frequency band is less than a first threshold; and modifying an analog gain applied to the received signal based on the transmit power.

Aspect 2: The method of aspect 1, wherein the modifying the analog gain further comprises: modifying the analog gain in response to the transmit power being greater than a second threshold.

Aspect 3: The method of aspect 2, wherein the modifying the analog gain in response to the transmit power being greater than the second threshold further comprises: increasing a gain state of a low noise amplifier (LNA) of a receiver of the UE to reduce the analog gain applied to the LNA in response to the transmit power being greater than the second threshold.

Aspect 4: The method of aspect 2 or 3, further comprising: setting the analog gain applied to the received signal based on a receive power of the received signal in response to the transmit power being less than the second threshold.

Aspect 5: The method of any of aspects 2 through 4, further comprising: identifying the transmit power as an expected transmit power in a next time element.

Aspect 6: The method of aspect 5, wherein the next time element is a slot or a symbol.

Aspect 7: The method of aspect 5 or 6, further comprising: requesting, by a receive antenna gain control (AGC) module of a receiver of the UE, the expected transmit power from a transmit AGC module of a transmitter of the UE.

Aspect 8: The method of any of aspects 2 through 7, wherein the modifying the analog gain further comprises: modifying an estimated receive signal strength indicator (RSSI) of the received signal to produce a modified estimated RSSI in response to the transmit power being greater than the second threshold; and determining a gain state of a low noise amplifier (LNA) of a receiver of the UE based on the modified estimated RSSI.

Aspect 9: The method of aspect 8, wherein the modifying the estimated RSSI further comprises: adding a static bias to the estimated RSSI to produce the modified estimated RSSI.

Aspect 10: The method of aspect 9, further comprising: adding a hysteresis to the static bias to produce the modified estimated RSSI.

Aspect 11: The method of aspect 1, wherein the modifying the analog gain further comprises: estimating a first RSSI of the received signal without a transmit leakage component corresponding to a portion of the transmit power leaking into the received signal; identifying a first gain state to be applied to the received signal based on the first RSSI; estimating a second RSSI of the transmit leakage component; identifying a second gain state to be applied to the received signal based on the second RSSI; and selecting a maximum gain state between the first gain state and the second gain state to apply to the received signal.

Aspect 12: The method of aspect 11, wherein the estimating the first RSSI further comprises: estimating a total RSSI comprising the received signal and the transmit leakage power component; removing a transmit leakage RSSI of the transmit leakage power component from the total RSSI to produce a receive RSSI; and reducing the receive RSSI by a first setpoint amount of an analog-to-digital (ADC) in a receiver of the UE to produce the first RSSI, wherein the first setpoint amount is associated with the receive RSSI.

Aspect 13: The method of aspect 12, wherein the estimating the second RSSI further comprises: estimating the transmit leakage RSSI of the transmit leakage power component; and reducing the transmit leakage RSSI by a second setpoint amount of the ADC associated with the transmit leakage RSSI to produce the second RSSI.

Aspect 14: The method of aspect 13, wherein the estimating the transmit leakage RSSI further comprises: capturing a wideband signal including the received signal and the transmit leakage power component; rotating the wideband signal to re-center the wideband signal around a transmit center frequency of the transmit signal to produce a rotated signal; filtering the rotated signal to produce the transmit leakage power component; and estimating the transmit leakage RSSI of the transmit leakage power component.

Aspect 15: The method of aspect 14, wherein the capturing the wideband signal further comprises: increasing a sampling rate of the ADC to capture the wideband signal; and tuning a filter of the receiver to include the transmit leakage power component.

Aspect 16: The method of aspect 13, wherein the estimating the transmit leakage RSSI further comprises: capturing the received signal including an attenuated version of the transmit leakage power component; rotating the received signal to re-center the received signal around a transmit center frequency of the transmit signal to produce a rotated signal; filtering the rotated signal to produce the attenuated version of the transmit leakage power component; estimating an attenuated RSSI of the transmit leakage power component; and scaling the attenuated RSSI by a scaling factor to produce the transmit leakage RSSI.

Aspect 17: The method of aspect 16, wherein the capturing the received signal further comprises: setting a sampling rate of the ADC to capture the received signal in the second frequency band; and filtering the received signal to produce the attenuated version of the transmit leakage power component.

Aspect 18: The method of aspect 16 or 17, wherein the scaling the attenuated RSSI further comprises: accessing a look-up table (LUT) mapping the scaling factor to the attenuated RSSI based on the frequency separation.

Aspect 19: An apparatus configured for wireless communication at a user equipment (UE) comprising one or more memories and one or more processors coupled to the one or more memories, the one or more processors configured to perform a method of any of aspects 1 through 18.

Aspect 20: An apparatus configured for wireless communication at a user equipment (UE) comprising means for performing a method of any of aspects 1 through 18.

Aspect 21: A non-transitory computer-readable medium having stored therein instructions executable by one or more processors of a user equipment (UE) to perform a method of any one of aspects 1 through 18.

Several aspects of a wireless communication network have been presented with reference to an exemplary implementation. As those skilled in the art will readily appreciate, various aspects described throughout this disclosure may be extended to other telecommunication systems, network architectures and communication standards.

By way of example, various aspects may be implemented within other systems defined by 3GPP, such as Long-Term Evolution (LTE), the Evolved Packet System (EPS), the Universal Mobile Telecommunication System (UMTS), and/or the Global System for Mobile (GSM). Various aspects may also be extended to systems defined by the 3rd Generation Partnership Project 2 (3GPP2), such as CDMA2000 and/or Evolution-Data Optimized (EV-DO). Other examples may be implemented within systems employing IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another—even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in FIGS. 1-17 may be rearranged and/or combined into a single component, step, feature or function or embodied in several components, steps, or functions. Additional elements, components, steps, and/or functions may also be added without departing from novel features disclosed herein. The apparatus, devices, and/or components illustrated in FIGS. 1, 2, 5, 11, and/or 16 may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

1. An apparatus configured for wireless communication at a user equipment (UE), comprising:
one or more memories; and
one or more processors coupled to the one or more memories, wherein the one or more processors are configured to cause the UE to:
transmit a first signal at a transmit power via a first frequency band;
receive a second signal via a second frequency band.
modify an analog gain applied to the second signal based on the transmit power.

2. The apparatus of claim 1, wherein the one or more processors are further configured to cause the UE to:
determine a frequency separation between the first frequency band and the second frequency band; and
modify the analog gain in response to the frequency separation being determined.

3-18. (canceled)

19. A method operable at a user equipment (UE), the method comprising:
transmitting a first signal at a transmit power via a first frequency band;
receiving a second signal via a second frequency band; and
modifying an analog gain applied to the second signal based on the transmit power.

20. (canceled)

21. The apparatus of claim 1, wherein the first frequency band and the second frequency band form a frequency division duplex (FDD) pair.

22. The method of claim 19, further comprising:
determining a frequency separation between the first frequency band and the second frequency band; and
modifying the analog gain in response to the frequency separation being determined.

23. The method of claim 19, wherein the first frequency band and the second frequency band form a frequency division duplex (FDD) pair.

24. A non-transitory computer-readable medium having stored therein instructions executable by one or more processors of a user equipment (UE) to cause the UE to:
transmit a first signal at a transmit power via a first frequency band;
receive a second signal via a second frequency band; and
modify an analog gain applied to the second signal based on the transmit power.

25. The non-transitory computer readable medium of claim 24, further comprising instructions executable by the one or more processors of the UE to cause the UE to:
determine a frequency separation between the first frequency band and the second frequency band; and
modify the analog gain in response to the frequency separation being determined.

26. The non-transitory computer readable medium of claim 24, wherein the first frequency band and the second frequency band form a frequency division duplex (FDD) pair.
